(19) United States
(12) Patent Application Publication
(10) Pub. No.: US 2017/0326459 A1
(43) Pub. Date: Nov. 16, 2017

(54) SYSTEMS AND METHODS FOR PROVIDING A MEDIA ASSET ASSOCIATED WITH AN ACTION THAT AFFECTS A USER'S FANTASY SPORTS SCORE

(71) Applicant: Rovi Guides, Inc., San Carlos, CA (US)

(72) Inventor: Erick Kenneth Ong, Burlingame, CA (US)

(21) Appl. No.: 15/154,107

(22) Filed: May 13, 2016

(51) Int. Cl. A63F 13/828; A63F 13/30; A63F 13/25

(52) U.S. Cl. CPC A63F 13/828; A63F 13/25; A63F 13/30

(57) ABSTRACT

Systems and methods for providing a user access to media assets associated with actions that affect the user's fantasy sports score. These systems and methods, upon receiving a notification of an action that affects the user's fantasy sports score, generate for display a media asset associated with the action that the user has a right to access by: identifying a media asset associated with the action, determining an access right of the media asset, and determining whether the user has a right to access the media asset based on the access right of the media asset and an access right granted to the user in a user subscription. This eliminates the need for the user to manually identify media assets associated with the action that the user has access to and ensures that the user does not miss viewing media assets associated with the actions.

### BACKGROUND

In known fantasy sports contests, a user (i.e., a fantasy sports contestant) selects a roster, a team, a particular individual, or a group of individuals in a season-long athletic competition. Fantasy sports contests are typically based on real-life team sports (e.g., football, baseball, basketball, hockey, soccer, and rugby), real-life athletic events in which individuals compete (e.g., golf, tennis, and automotive racing), and real-life sporting events involving animals (e.g., horse and dog racing). The user is given the ability to take on the role of a fictional general manager with powers which may include the ability to draft, trade, dismiss and otherwise manage the user's fantasy sports roster selections.

Known fantasy sports contest systems provide services to users which include providing statistical information for real-life athletic competition and tracking users' standings (i.e., rankings) in fantasy sports contests. Known fantasy sports contest systems typically determine a user's standing (i.e., ranking) in a fantasy sports contest based on the performance of the user's fantasy sports roster selections in real-life athletic competition. For example, a conventional fantasy sports contest system might award five fantasy sports contest points to the user for every goal scored in real-life by a member of the user's fantasy sports contest soccer team. Generally, the user who has accumulated the most fantasy sports contest points by the conclusion of a fantasy sports contest (e.g., the end of a real-life athletic season) is the overall winner of that fantasy sports contest.

A user participating in a fantasy sports contest may wish to view content associated with actions that affect the user's fantasy sports score in real-time. However, because the user's fantasy sports roster is likely to be comprised of real-life sports players from a variety of real-life sports teams, a user has to track all content associated with the variety of real-life sports teams in order to identify content associated with actions that affect the user's fantasy sports score. This problem is further compounded by the fact that content associated with actions that affect the user's fantasy sports score is typically available from a plethora of content sources, each of which has its own access policy. Thus, in current systems, a user has to manually identify content associated with actions that affect the user's fantasy sports score and determine whether the user has the right to access the content. This can be difficult and time consuming process and as a result, a user may miss viewing some content associated with actions that affect the user's fantasy sports score.

### SUMMARY

Systems and methods are provided herein for providing a user access to media assets associated with actions that affect the user's fantasy sports score. These systems and methods receive a notification of an action that affects the user's fantasy sports score, identify a media asset associated with the action that the user has a right to access, and display a portion of the media asset corresponding to the action.

An interactive media guidance application receives a data structure that includes a first field corresponding to an action in a real-life sporting event that affects a fantasy sports score of a user and a second field corresponding to an identification of the real-life sporting event corresponding to the action. Actions that affects a fantasy sports score of a user may be events performed by real-life sports player on the user's fantasy team roster during a real-life sports event (e.g., point, 3 point shot, dunk shot, rebound, assist, steal, block, turnover for a fantasy basketball contest). Additionally, actions can be events that indirectly affect the user's fantasy score (e.g., real-life sports player on the user's fantasy team roster sustaining an injury and not being able to play for the rest of the season).

For example, the interactive media guidance application may receive, for a user participating in a fantasy basketball contest, a record containing an action description field and a real-life sporting event identifier field. The interactive media guidance application may receive a record with fields “dunk shot 10 minutes into the game” and “Apr. 19, 2016 Cleveland Cavaliers-Los Angeles Lakers, 10:30 PM EST.” In this case, “dunk shot 10 minutes into the game” is the first field corresponding to an action (i.e., dunk shot) in a real-life sporting event that affects the fantasy sports score of the user and “Apr. 19, 2016 Cleveland Cavaliers-Los Angeles Lakers, 10:30 PM EST” is the second field corresponding to an identification of the real-life sporting event corresponding to the action.

The interactive media guidance application retrieves metadata corresponding to media assets provided by a plurality of content sources. The interactive media guidance application may query, using database management languages (e.g., SQL, JAPQL, CODASYL or another suitable language), content listings databases of the plurality of content sources for media assets associated with real-life sporting events. For example, for a user participating in a fantasy basketball contest, the interactive media guidance application may query content listings databases of the plurality of content sources (e.g., broadcast source 1, broadcast source 2, over-the-top content (OTT) source 1) for media assets associated with real-life basketball games during a specific time period. For example, interactive media guidance application may query for live real-life basketball games or for real-life basketball games that occurred on a certain date.

The interactive media guidance application may, upon determining the media assets associated with real-life sporting events, access data structures associated with each of the media assets to retrieve metadata associated with each of the media assets. For example, based on the query results, the interactive media guidance application may determine that media asset 1 provided by broadcast source 1, media asset 2 provided by broadcast source 2, and media asset 3 provided by over-the-top content (OTT) source 1 are all media assets associated with real-life basketball games.

The interactive media guidance application parses the metadata to determine real-life sporting events in each of the media assets. For example, the interactive media guidance application may use a metadata extraction tool to extract the real-life sporting event corresponding to each of the media assets from the associated metadata. For example, by parsing the metadata for media asset 1, the interactive media guidance application may determine that the real-life sporting event corresponding to media asset 1 is the “Apr. 19, 2016 Golden State Warriors-Chicago Bulls game, 10:00 PM EST game.” Similarly, the interactive media guidance application may determine that the real-life sporting events corresponding to media asset 2 and media asset 3 are the “Apr. 19, 2016 Miami Heat-Dallas Mavericks, 9:55 PM EST game” and the “Apr. 19, 2016 Cleveland Cavaliers-Los Angeles Lakers, 10:30 PM EST game” respectively.

The interactive media guidance application compares the real-life sporting events to the real-life sporting event to determine a media asset of the media assets corresponding to the real-life sporting event. For example, the interactive media guidance application may use a Boolean comparison function to compare the real-life sporting events extracted from the metadata of the media assets (e.g., “Apr. 19, 2016 Golden State Warriors-Chicago Bulls game, 10:00 PM EST game,” “Apr. 19, 2016 Miami Heat-Dallas Mavericks, 9:55 PM EST game,” “Apr. 19, 2016 Cleveland Cavaliers-Los Angeles Lakers, 10:30 PM EST game”) with the real-life sporting event received in the data structure to determine if there is a match. Following from the example above, the Boolean comparison function will return a “true” result when the real-life sporting event from the metadata of media asset 3 is compared to the real-life sporting event received in the data structure. Based on this result, the interactive media guidance application can determine that media asset 3 corresponds to the Apr. 19, 2016 Cleveland Cavaliers-Los Angeles Lakers, 10:30 PM EST game.

The interactive media guidance application in response to determining the media asset corresponding to the real-life sporting event, determines an access right for the media asset. The access right for a media asset defines the criterion that has to be fulfilled in order for a user to have access to the media asset. For example, the access right for a media asset may be “public” and all users have free access. Access right for a media asset may be “subscribers only” and only users who have a subscription for the content source of the media asset have access to the media asset. Access right for a media asset may also be “purchase” or “rent.” Access right may be such that the user has to perform a certain action in order to gain access to the media asset. For example, access right for a media asset provided by a sports blogger on his sports blog may be that the user has to leave a comment on the sports blog in order to gain access.

The interactive media guidance application may refer to data embedded in the media asset to determine the access right for the media asset. Additionally or alternatively, the interactive media guidance application may extract the access right for a media asset from the metadata associated with the media asset using processes described previously. Additionally or alternatively, the interactive media guidance application may access a database (e.g., a content rights management database) associated with the content source providing the media asset to determine the access right for the media asset. Following from the example above, the interactive media guidance application may determine that the access right for media asset 3 is that access is granted to all users who have a subscription for OTT source 1.

The interactive media guidance application compares the access right for the media asset to an access right granted in a user subscription. The interactive media guidance application may access a database associated with the user (e.g., a database that stores information about the user's subscription account for a particular content source) to determine the access right granted to the user in a user subscription. From the previous example, the interactive media guidance application may access a database associated with user's subscription account for OTT source 1 to determine access right granted to the user for content from OTT source 1. The interactive media guidance application may then use a Boolean comparison function to determine whether the access right for the media asset corresponds to the access right granted to the user in the user subscription.

The interactive media guidance application, in response to the determining that the access right for the media asset corresponds to the access right granted in the user subscription, generates for display a notification that the action has occurred simultaneously with a portion of the media asset corresponding to the action. Following from the example above, upon receiving a “true’ result from the Boolean comparison function, the interactive media guidance application may generate for display a notification that says “Dunk shot in the Cleveland Cavaliers-Los Angeles Lakers game” simultaneously with a clip from media asset 3 that shows the dunk shot being made.

The interactive media guidance application may determine portion of the media asset corresponding to the action by parsing the metadata of the media asset for game highlights information and comparing the information with the first field that describes the action that affects the user's fantasy score. For example, game highlights information contained in the metadata for media asset 3 may be “dunk shot at 2:00-4:00 minutes,” “steal at 6:50-7:45 minutes” and “dunk shot at 9:00-11:00 minutes.” In this case, based on the first field (e.g., “dunk shot 10 minutes into the game”), the interactive media guidance application determines that the “dunk shot shot at 9:00-11:00 minutes” is the portion of the media asset corresponding to the action. The interactive media guidance application then displays portion of media asset ranging from 9:00-11:00 minutes simultaneously with the notification. Alternatively, the interactive media guidance application may determine a time in the media asset when the action occurred and display a portion of the media asset ranging from a pre-defined time before the time of the action to a pre-defined time after the time of the action. For example, the interactive media guidance application may determine that the action occurred at the 10 minute point in media asset 3 and may show portion of the media asset ranging from 45 seconds before the 10 minute point to 45 seconds after the 10 minute point (i.e., portion of media asset ranging from 9:15-10:45 minutes).

In some embodiments, the interactive media guidance application receives, in the data structure, a third field corresponding to a participant in the real-life sporting event corresponding to the action. For example, the interactive media guidance application may receive a record that includes a real-life sporting event participant field in addition to an action description field and a real-life sporting event identifier field. From the previous example, the interactive media guidance application may further receive in the record the field “LeBron James” which corresponds to a participant in the real-life sporting event (“Apr. 19, 2016 Cleveland Cavaliers-Los Angeles Lakers, 10:30 PM EST”) corresponding to the action (“dunk shot 10 minutes into the game”).

In some embodiments, the interactive media guidance application parses the metadata to determine participants in each of the media assets and compares participants to the participant to determine the media asset of the media assets corresponding to the real-life sporting event. The interactive media guidance application may, using a metadata extraction tool, parse the metadata associated with each of the media assets to extract the participants corresponding to each of the media assets. From the previous example, by parsing the metadata for media asset 1, the interactive media guidance application may determine that the participants corresponding to media asset 1 are “Stephen Curry” and “Derrick Rose.” Similarly, the interactive media guidance application may determine that the participants corresponding to media asset 2 are “Dwyane Wade” and “David Lee” and the participants corresponding to media asset 3 are “LeBron James” and “Nick Young.”

The interactive media guidance application may use a Boolean comparison function to compare participants extracted from the metadata of the media assets to the participant received in the data structure to determine if there is a match. From the previous example, the Boolean comparison function returns a “true” result when participants from the metadata of media asset 3 (e.g., “Stephen Curry,” “Derrick Rose,” “Dwyane Wade,” “David Lee,” “LeBron James,” “Nick Young”) are compared to the participant (“LeBron James”) received in the data structure. Based on this result, the interactive media guidance application can determine that media asset 3 corresponds to the Apr. 19, 2016 Cleveland Cavaliers-Los Angeles Lakers, 10:30 PM EST game.

In some embodiments, the interactive media guidance application receives, in the data structure, a fourth field corresponding to a game portion in the real-life sporting event corresponding to the action. For example, the interactive media guidance application may receive a record that includes a game portion field in addition to an action description field and a real-life sporting event identifier field. The game portion field may provide pertinent details about the action. Following from the previous example, the interactive media guidance application may further receive in the record the field “LeBron James scored a 3-point shot, 9:00-11:00 minutes” which corresponds to a game portion in the real-life sporting event (“Apr. 19, 2016 Cleveland Cavaliers-Los Angeles Lakers, 10:30 PM EST”) corresponding to the action (“dunk shot 10 minutes into the game”).

In some embodiments, the interactive media guidance application parses the metadata to determine game portions in each of the media assets. For example, the interactive media guidance application may parse the metadata of media asset 1, media asset 2 and media asset 3 using processes described previously to extract metadata describing the content of these media assets. The interactive media guidance application may determine that content description metadata associated with media asset 3 is “Nick Young scored a dunk shot at 2:00-4:00 minutes,” “Nick Young performed a steal at 6:50-7:45 minutes” and “LeBron James scored a dunk shot at 9:00-11:00 minutes.”

In some embodiments, the interactive media guidance application compares game portions to the game portion to determine the media asset of the media assets corresponding to the real-life sporting event. For example, interactive media guidance application may use a Boolean comparison function to compare game portions extracted from the metadata of the media assets (e.g., “Nick Young scored a dunk shot at 2:00-4:00 minutes,” “Nick Young performed a steal at 6:50-7:45 minutes” and “LeBron James scored a dunk shot at 9:00-11:00 minutes”) with the game portion received in the record “LeBron James scored a dunk shot, 9:00-11:00 minutes”) to determine if there is a match. In this instance, the Boolean comparison function returns a “true” result when game portions from the metadata of media asset 3 are compared to the game portion received in the data structure. Based on this result, the interactive media guidance application can determine that media asset 3 corresponds to the Apr. 19, 2016 Cleveland Cavaliers-Los Angeles Lakers, 10:30 PM EST game.

In some embodiments, the interactive media guidance application determines that content source providing the media asset requires authentication credential. Authentication credential (e.g., user name, password) is any unique identifiers associated with the user such as a string of characters or bio-metric data (e.g., finger print, retina scan, voice recognition or another suitable bio-metric data). The interactive media guidance application may receive a communication from the content source that authentication credential is required when the interactive media guidance application initiates the process to generate for display the portion of the media asset corresponding to the action. Alternatively, the interactive media guidance application may access a database associated with the content source prior to accessing the media asset to determine whether the content source requires an authentication credential. For example, the interactive media guidance application may determine that in order to access media asset 3 from OTT source 1, a user password has to be provided to OTT source 1.

In some embodiments, the interactive media guidance application accesses a profile data structure of the user corresponding to the content source to retrieve value of the authentication credential and provides the content source the authentication credential such that the user does not have to manually enter the authentication credential. For example, the interactive media guidance application may access the user profile data structure in the database associated with user's subscription account for OTT source 1 to retrieve the value of the authentication credential (e.g., password “MW_1986”). The interactive media guidance application may provide the authentication credential (i.e., password “MW_1986”) to the content source without requiring any user intervention so that the user has automated access to the media asset.

In some embodiments, the interactive media guidance application, in response to the determining that the access right for the media asset does not correspond to the access right granted in the user subscription, generates for display the notification that the action has occurred without the portion of the media asset corresponding to the action. For example, the interactive media guidance application may determine that the access right for media asset 3 is that access is granted to all users who have a premier subscription for OTT source 1. The interactive media guidance application may determine, by accessing a database associated with user's subscription account for OTT source 1, that the user has a basic subscription for OTT source 1. In this instance, the interactive media guidance application determines that the two access rights do not correspond and generates for display only the notification. For example, the interactive media guidance application may generate for display only the notification “dunk shot in the Cleveland Cavaliers-Los Angeles Lakers game.”

In some embodiments, the interactive media guidance application, upon determining that the access right for the media asset does not correspond to the access right granted in the user subscription, includes in the notification an option to request access to the media asset. For example, the interactive media guidance application may generate for display a media asset identifier for the media asset corresponding to the action and a selectable option associated with the media asset identifier to allow the user to request access to the media asset. For example, the interactive media guidance application may generate for display a media asset identifier for media asset 3 along with a selectable “request access” option. In some embodiments, the interactive media guidance application may also generate for display the criteria (e.g., subscribe to content source, purchase the media asset, leave a comment on the content provider's webpage) that has to be fulfilled in order to gain access to the media asset.

In some embodiments, the interactive media guidance application may determine that there are numerous media assets corresponding to the action that the user can request access to. The interactive media guidance application may generate for display media asset identifiers for all these media assets to allow the user to select the media asset that the user deems most appropriate. In some embodiments, the interactive media guidance application may display the media assets organized according to a ranking criteria. For example, the interactive media guidance application may generate for display the media asset identifiers such that the media asset identifier corresponding to the least expensive media asset is listed first. The interactive media guidance application may use a sorting algorithm (e.g., quicksort, heapsort, mergesort or another suitable algorithm) to organize the media assets according to a predetermined ranking criteria.

In some embodiments, the interactive media guidance application displays the notification and the portion of the media asset corresponding to the action simultaneously with a program currently being displayed. For example, if the user is currently watching the program “Game of Thrones,” the interactive media guidance application may generate for display the notification “dunk shot in the Cleveland Cavaliers-Los Angeles Lakers game” and the clip from media asset 3 that shows the dunk shot being made over the “Game of Thrones” video window.

The interactive media guidance application may use a variety of display formats (e.g., overlay, banner, picture-in-picture (“PIP”) and other suitable display formats)for the simultaneous display of the notification, the portion of the media asset corresponding to the action and the current program. For example, the interactive media guidance application may display the notification as an overlay over either or both the portion of the media asset corresponding to the action and the program currently being displayed. Alternatively, the interactive media guidance application may display the three items in three non-overlapping areas.

In some embodiments, the interactive media guidance application receives a user selection of programs during which the notification and the portion of the media asset corresponding to the action are not to be displayed. For example, the interactive media guidance application may generate for display the prompt “Choose programs during which a notification is not to be displayed” along with program identifiers and a selectable option “select” corresponding to each of the program identifiers. For example, the interactive media guidance application may receive a user selection of the “select” option corresponding to the program “Game of Thrones,” indicating that a notification is not be displayed when “Game of Thrones” is being displayed. In some embodiments, the interactive media guidance application, upon receiving user selection of programs during which the notification is not to be displayed, stores the program identifiers corresponding to the user selection of programs in a data structure (e.g., “no notification program list”).

In some embodiments, the interactive media guidance application parses metadata corresponding to the program currently being displayed to determine an identifier of the program currently being displayed. The interactive media guidance application may parse the metadata of the program currently being displayed using processes described previously to extract the program identifier (e.g., program name, program serial code or any other suitable identifier).

In some embodiments, the interactive media guidance application determines that program currently being displayed is included in the selection of programs during which the notification and the portion of the media asset corresponding to the action are not to be displayed by comparing the identifier of the program currently being displayed with identifiers of programs during which the notification is not to be displayed. For example, the interactive media guidance application may use a Boolean comparison function to compare the program identifier of the program currently being displayed with the program identifiers stored in the “no notification program list” data structure. The interactive media guidance application may determine, upon receiving a “true” result from the Boolean comparison function, that the program currently being displayed is included in the selection of programs during which the notification is not to be displayed.

In some embodiments, the interactive media guidance application, upon determining that the program currently being displayed is included in the selection of programs, does not generate for display the notification and the portion of the media asset corresponding to the action. From the previous example, while “Game of Thrones” is being displayed, the interactive media guidance application does not generate for display the notification and the portion of the media asset corresponding to the action.

In some embodiments, interactive media guidance application receives a selection of programs during which the notification is not to be displayed. In these cases, if the current program is included in the selected programs, the interactive media guidance application may generate for display only the portion of the media asset corresponding to the action simultaneously with the current program. In alternative embodiments, interactive media guidance application receives a selection of programs during which the portion of the media asset corresponding to the action is not to be displayed. In these cases, if the current program is included in the selected programs, the interactive media guidance application may generate for display only the notification simultaneously with the current program.

In some embodiments, the interactive media guidance application receives a user selection of time periods during which the notification and/or the portion of the media asset corresponding to the action are not to be displayed. In these cases, the interactive media guidance application may compare the current time with the selected time periods to determine whether to generate for display the notification and/or the portion of the media asset corresponding to the action. For example, the user may wish to not receive the notifications and portions of the media asset corresponding to the action during work hours of 9:00 am to 5:00 pm.

In some embodiments, the interactive media guidance application includes in the notification an option to view the fantasy sports score of the user. For example, the interactive media guidance application may include in the notification for a user participating in a fantasy basketball contest a selectable option “View current fantasy basketball score.” In some embodiments, the interactive media guidance application, in response to receiving a selection of the option view the fantasy sports score of the user, retrieves a value corresponding to the fantasy sports score from a data structure corresponding to a fantasy sports team of the user. In some embodiments, the interactive media guidance application generates for display the fantasy sports score of the user. For example, upon receiving a user selection of the “View current fantasy basketball score” option, the interactive media guidance application may access a data structure associated with the user's fantasy basketball team to retrieve the current value (e.g., 50) of the user's fantasy basketball score. The interactive media guidance application may then generate for display a prompt such as “Your current score is 50” to inform the user of the current score.

In some embodiments, the interactive media guidance application receives a user selection of actions in real-life sporting events that affect the fantasy sports score of the user for which the notification and the portion of the media asset corresponding to the action are not to be displayed. For example, for a user participating in a fantasy basketball contest, the interactive media guidance application may receive a selection of actions (e.g., any of dunk shot, rebound, assist, steal, block, turnover) for which the notification and the portion of the media asset corresponding to the action are not to be displayed. In some embodiments, the interactive media guidance application, upon receiving user selection of actions (e.g., dunk shot and assist), stores fields corresponding to the actions in a data structure (e.g., “no notification action list”).

In some embodiments, the interactive media guidance application determines that the action is included in the user selection of actions by comparing the first field corresponding to the action to fields corresponding to the user selection of actions and in response to the determining, the interactive media guidance application does not generate for display the notification and the portion of the media asset corresponding to the action. For example, the interactive media guidance application may use a Boolean comparison function to compare the first field (e.g., dunk shot 10 minutes into the game) with the fields corresponding to actions (e.g., dunk shot and assist) stored in the “no notification action list” data structure. In this instance, the interactive media guidance application determines that the action is included in the user selection of actions based on a “true” result from the Boolean comparison function and does not generate for display the notification and the portion of the media asset corresponding to the action.

In some embodiments, the interactive media guidance application receives a user selection of real-life sports player on the user's fantasy team roster for whom the notification and the portion of the media asset corresponding to the action are not to be displayed. For example, the user may indicate that the user does not wish to be notified of any action performed by real-life sports player “LeBron James.” The interactive media guidance application may store fields corresponding to the user selection of real-life sports players on the user's fantasy team roster in a data structure (e.g., “no notification sports players list”). The interactive media guidance application may compare the third field received in the data structure with the fields in the “no notification sports players list” to determine whether the notification and the portion of the media asset corresponding to the action are to be displayed, using processes similar to the ones described previously.

In some embodiments, the interactive media guidance application monitors the number of notifications displayed in a given period of time. Upon determining that the number of notifications displayed has exceeded a threshold number of notifications to be displayed in a given period of time, the interactive media guidance application may not generate for display any further notification that an action has occurred simultaneously with a portion of media asset corresponding to the action until a pre-defined amount of time has elapsed. For example, the interactive media guidance application may determine that the threshold number of notifications allowed to be displayed during an hour is 4. After displaying 4 notifications and associated portions of media assets during a time period of 45 minutes, the interactive media guidance application may refrain from generating for display a notification for any further action that occurs during the remaining 15 minutes. In alternative embodiments, interactive media guidance application may generate for display a notification that an action has occurred simultaneously with a portion of a media asset corresponding to the action after determining that a minimum amount of time has elapsed between the current notification and a previous notification that was displayed.

A user participating in a fantasy sports contest may have real-life sports players from a variety of real-life sports teams on the user's fantasy sports roster. The user may wish to be apprised of all actions that affect the user's fantasy score and view media assets associated with these actions. Conventional systems are limited to providing users with notifications of actions that affect the user's fantasy sports score without automated access to media assets associated with the actions. As a result, the user has to manually identify media assets associated with actions that affect the user's fantasy sports score and determine whether the user has a right to access these media assets.

Given that the actions that affect the user's fantasy score are performed by players from a variety of real-life sports teams, the media assets associated with the actions are likely to be available from a plethora of content sources, each of which has its own access policy. Consequently, manually identifying content sources that the user has a right to access is a cumbersome process. Systems and methods provided herein address this issue by displaying a portion of the media asset corresponding to the action simultaneously with the notification of the action. The invention achieves this by identifying a media asset associated with the action, determining the access right of the media asset, and determining whether the user has a right to access the media asset.

It should be noted the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative display of the interactive media guidance application in accordance with some embodiments of the disclosure;

FIG. 2 depicts another illustrative display of the interactive media guidance application in accordance with some embodiments of the disclosure;

FIG. 3 depicts yet another illustrative display of the interactive media guidance application in accordance with some embodiments of the disclosure;

FIG. 4 depicts yet another illustrative display of the interactive media guidance application in accordance with some embodiments of the disclosure;

FIG. 5 shows an illustrative embodiment of a display screen that may be used to provide media guidance application listings and other media guidance information, in accordance with some embodiments of the disclosure;

FIG. 6 shows another illustrative embodiment of a display screen that may be used to provide media guidance application listings, in accordance with some embodiments of the disclosure;

FIG. 7 is a block diagram of an illustrative user equipment (UE) device in accordance with some embodiments of the disclosure;

FIG. 8 is a block diagram of an illustrative media system in accordance with some embodiments of the disclosure;

FIG. 9 is a flowchart of illustrative steps involved in providing a user access to a media asset associated with an action that affects the user's fantasy sports score in accordance with some embodiments of the disclosure;

FIG. 10 is a flowchart of illustrative steps involved in step 902 (FIG. 9) when receiving the data structure that includes the first field corresponding to the action in a real-life sporting event that affects the fantasy sports score of the user and the second field corresponding to the identification of the real-life sporting event corresponding to the action in accordance with some embodiments of the disclosure;

FIG. 11 is a flowchart of illustrative steps involved in step 908 (FIG. 9) when comparing the real-life sporting events to the real-life sporting event to determine a media asset of the media assets corresponding to the real-life sporting event in accordance with some embodiments of the disclosure; and

FIG. 12 is a flowchart of illustrative steps involved in step 912 (FIG. 9) when determining an access right for the media asset in accordance with some embodiments of the disclosure.

### DETAILED DESCRIPTION

As referred to herein, an “interactive media guidance application,” or a “media guidance application” or, sometimes, a “media guidance application” or a “guidance application” is an application that allows a user to consume, and/or navigate to content. In some embodiments, the media guidance application may be provided as an online application (i.e., provided on a website), or as a stand-alone application on a server, user device. In some embodiments, control circuitry installed on various devices and platforms may execute the media guidance application, as described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and nonvolatile computer memory or storage devices such as a hard disk, floppy disk, USB drive, DVD, CD, media card, register memory, processor caches, Random Access Memory (“RAM”).

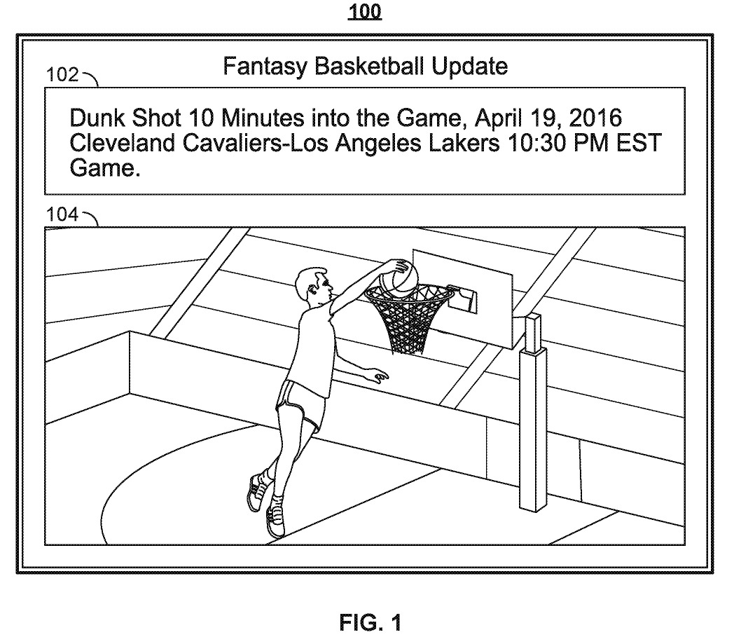

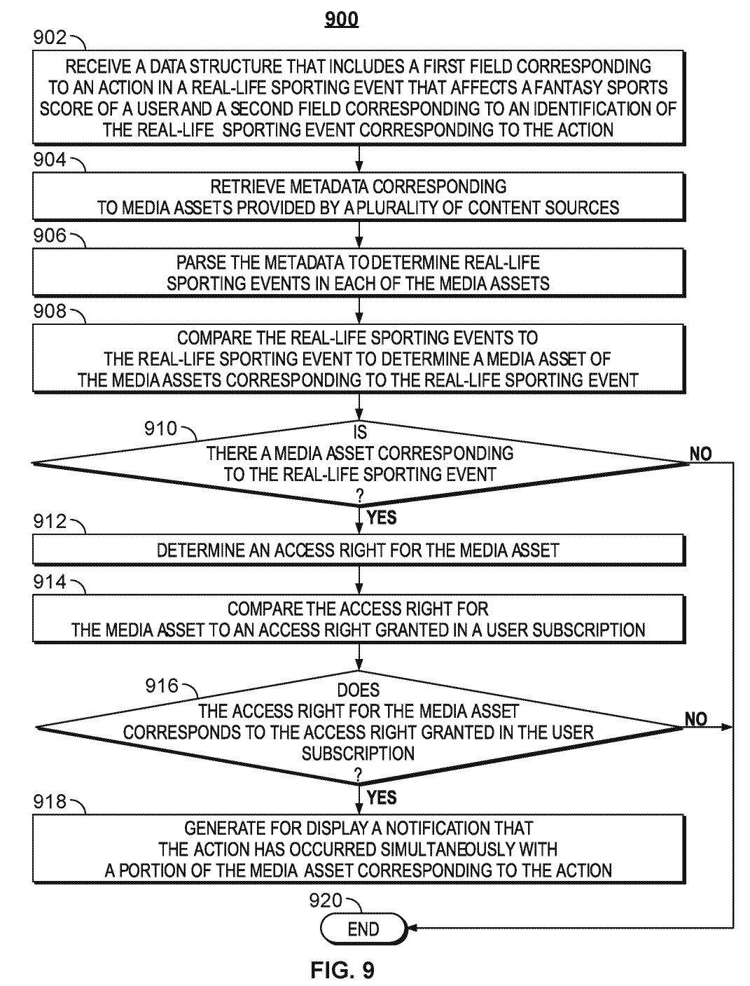

FIG. 1 depicts an illustrative display of the interactive media guidance application in accordance with some embodiments of the disclosure. FIG. 1 depicts an illustrative display 100 which may be displayed on any user device (e.g., user television equipment 802, user computer equipment 804, and wireless user communications device 806, described in FIG. 8 below). Control circuitry 704 may cause displays to be displayed on display 712 using the one or more of the processes described in FIGS. 9-12.

Display 100 is an example of a display generated by the interactive media guidance application to provide a user a notification that an action that affects a fantasy sports score has occurred in a real-life sporting event. Display 100 includes a notification of the action “dunk shot 10 minutes into the game, Apr. 19, 2016 Cleveland Cavaliers-Los Angeles Lakers 10:30 PM EST game” 102 and a portion of the media asset corresponding to the action 104.

The interactive media guidance application receives a data structure that includes a first field corresponding to an action in a real-life sporting event that affects a fantasy sports score of a user and a second field corresponding to an identification of the real-life sporting event corresponding to the action. Actions that affects a fantasy sports score of a user may be events performed by real-life sports player on the user's fantasy team roster during a real-life sports event (e.g., point, 3 point shot, dunk shot, rebound, assist, steal, block, turnover for a fantasy basketball contest). Additionally, actions can be events that indirectly affect the user's fantasy score (e.g., real-life sports player on the user's fantasy team roster sustaining an injury and not being able to play for the rest of the season).

The interactive media guidance application may receive, for a user participating in a fantasy basketball contest, a record containing an action description field and a real-life sporting event identifier field. For example, the interactive media guidance application may receive a record with fields “dunk shot 10 minutes into the game” and “Apr. 19, 2016 Cleveland Cavaliers-Los Angeles Lakers, 10:30 PM EST.” In this case, “dunk shot 10 minutes into the game” is the first field corresponding to an action (i.e., dunk shot) in a real-life sporting event that affects the fantasy sports score of the user and “Apr. 19, 2016 Cleveland Cavaliers-Los Angeles Lakers, 10:30 PM EST” is the second field corresponding to an identification of the real-life sporting event corresponding to the action.

The interactive media guidance application retrieves metadata corresponding to media assets provided by a plurality of content sources. The interactive media guidance application may query, using database management languages (e.g., SQL, JAPQL, CODASYL), content listings databases of the plurality of content sources located at media content source 816 and media guidance data source 818 for media assets associated with live real-life sporting events. For example, for a user participating in a fantasy basketball contest, the interactive media guidance application may query content listings databases of the plurality of content sources (e.g., broadcast source 1, broadcast source 2, over-the-top content (OTT) source 1) for media assets associated with real-life basketball games. For example, interactive media guidance application may query for live real-life basketball games or for real-life basketball games that occurred on a certain date.

The interactive media guidance application may, upon determining the media assets associated with real-life sporting events, access data structures associated with each of the media assets to retrieve metadata corresponding with that media asset. For example, based on the query results, the interactive media guidance application may determine that media asset 1 provided by broadcast source 1, media asset 2 provided by broadcast source 2, and media asset 3 provided by over-the-top content (OTT) source 1 are all media assets associated with live real-life basketball games.

The interactive media guidance application parses the metadata to determine real-life sporting events in each of the media assets. For example, the interactive media guidance application may use a metadata extraction tool to extract the real-life sporting event corresponding to each of the media assets from the associated metadata. For example, by parsing the metadata for media asset 1, the interactive media guidance application may determine that the real-life sporting event corresponding to media asset 1 is the “Apr. 19, 2016 Golden State Warriors-Chicago Bulls game, 10:00 PM EST game.” Similarly, the interactive media guidance application may determine that the real-life sporting events corresponding to media asset 2 and media asset 3 are the “Apr. 19, 2016 Miami Heat-Dallas Mavericks, 9:55 PM EST game” and the “Apr. 19, 2016 Cleveland Cavaliers-Los Angeles Lakers, 10:30 PM EST game” respectively.

The interactive media guidance application compares the real-life sporting events to the real-life sporting event to determine a media asset of the media assets corresponding to the real-life sporting event. For example, the interactive media guidance application may use a Boolean comparison function to compare the real-life sporting events extracted from the metadata of the media assets (e.g., “Apr. 19, 2016 Golden State Warriors-Chicago Bulls game, 10:00 PM EST game,” “Apr. 19, 2016 Miami Heat-Dallas Mavericks, 9:55 PM EST game,” “Apr. 19, 2016 Cleveland Cavaliers-Los Angeles Lakers, 10:30 PM EST game”) with the real-life sporting event received in the data structure to determine if there is a match. Following from the example above, the Boolean comparison function will return a “true” result when the real-life sporting event from the metadata of media asset 3 is compared to the real-life sporting event received in the data structure. Based on this result, the interactive media guidance application can determine that media asset 3 corresponds to the Apr. 19, 2016 Cleveland Cavaliers-Los Angeles Lakers, 10:30 PM EST game.

The interactive media guidance application in response to determining the media asset corresponding to the real-life sporting event, determines an access right for the media asset. The access right for a media asset defines the criterion that has to be fulfilled in order for a user to have access to the media asset. For example, the access right for a media asset may be “public” and all users have free access. Access right for a media asset may be “subscribers only” and only users who have a subscription for the content source providing the media asset have access to the media asset. Access right for a media asset may also be “purchase” or “rent.” Access right may be such that the user has to perform a certain action in order to gain access to the media asset. For example, access right for a media asset provided by a sports blogger on his sports blog may be that the user has to leave a comment on the sports blog in order to gain access.

The interactive media guidance application may refer to data embedded in the media asset to determine the access right for the media asset. Additionally or alternatively, the interactive media guidance application may extract the access right for a media asset from the metadata associated with the media asset using processes described previously. Additionally or alternatively, the interactive media guidance application may access a database, located at media content source 816 and media guidance data source 818, associated with the content source providing the (e.g., a content rights management database) of the media asset to determine the access right for the media asset. Following from the example above, the interactive media guidance application may determine that the access right for media asset 3 is that access is granted to all users who have a subscription for OTT source 1.

The interactive media guidance application compares the access right for the media asset to an access right granted in a user subscription. The interactive media guidance application may access a database associated with the user (e.g., a database that stores information about the user's subscription account for a particular content source located at any of storage 708, media content source 816 and media guidance data source 818) to determine the access right granted to the user in a user subscription. From the previous example, the interactive media guidance application may access a database associated with user's subscription account for OTT source 1 to determine access right granted to the user for content from OTT source 1. The interactive media guidance application may then use a Boolean comparison function to determine whether the access right for the media asset corresponds to the access right granted to the user in a user subscription.

The interactive media guidance application, in response to the determining that the access right for the media asset corresponds to the access right granted in the user subscription, generates for display a notification that the action has occurred simultaneously with a portion of the media asset corresponding to the action. Following from the example above, upon receiving a “true’ result from the Boolean comparison function, the interactive media guidance application may generate for display a notification 102 that says “dunk shot 10 minutes into the game, Apr. 19, 2016 Cleveland Cavaliers-Los Angeles Lakers 10:30 PM EST game” simultaneously with a portion of the media asset corresponding to the action 104.

The interactive media guidance application may determine portion of the media asset corresponding to the action 104 by parsing the metadata of the media asset for game highlights information and comparing the information with the first field that describes the action that affects the user's fantasy score. For example, game highlights information contained in the metadata for media asset 3 may be “dunk shot at 2:00-4:00 minutes,” “steal at 6:50-7:45 minutes” and “dunk shot at 9:00-11:00 minutes.” In this case, based on the first field (e.g., “dunk shot 10 minutes into the game”), the interactive media guidance application determines that the “dunk shot at 9:00-11:00 minutes” is the portion of the media asset corresponding to the action. The interactive media guidance application then displays portion of media asset ranging from 9:00-11:00 minutes simultaneously with the notification. Alternatively, the interactive media guidance application may determine a time in the media asset when the action occurred and display a portion of the media asset ranging from a pre-defined time before the time of the action to a pre-defined time after the time of the action. For example, the interactive media guidance application may determine that the action occurred at the 10 minute point in media asset 3 and may show portion of the media asset ranging from 45 seconds before the 10 minute point to 45 seconds after the 10 minute point (i.e., portion of media asset ranging from 9:15-10:45 minutes).

In some embodiments, the interactive media guidance application receives, in the data structure, a third field corresponding to a participant in the real-life sporting event corresponding to the action. For example, the interactive media guidance application may receive a record that includes a real-life sporting event participant field in addition to an action description field and a real-life sporting event identifier field. From the previous example, the interactive media guidance application may further receive in the record the field “LeBron James” which corresponds to a participant in the real-life sporting event (“Apr. 19, 2016 Cleveland Cavaliers-Los Angeles Lakers, 10:30 PM EST”) corresponding to the action (“dunk shot 10 minutes into the game”).

In some embodiments, the interactive media guidance application parses the metadata to determine participants in each of the media assets and compares participants to the participant to determine the media asset of the media assets corresponding to the real-life sporting event. The interactive media guidance application may, using a metadata extraction tool, parse the metadata associated with each of the media assets to extract the participants corresponding to each of the media assets. From the previous example, by parsing the metadata for media asset 1, the interactive media guidance application may determine that the participants corresponding to media asset 1 are the “Stephen Curry” and “Derrick Rose.” Similarly, the interactive media guidance application may determine that the participants corresponding to media asset 2 are “Dwyane Wade” and “David Lee” and the participants corresponding to media asset 3 are “LeBron James” and “Nick Young.”

The interactive media guidance application may use a Boolean comparison function to compare participants extracted from the metadata of the media assets (e.g., “Stephen Curry,” “Derrick Rose,” “Dwyane Wade,” “David Lee,” “LeBron James,” “Nick Young”) to the participant received in the record (“LeBron James”) to determine if there is a match. From the previous example, the

Boolean comparison function returns a “true” result when participants from the metadata of media asset 3 are compared to the participant received in the data structure. Based on this result, the interactive media guidance application can determine that media asset 3 corresponds to the Apr. 19, 2016 Cleveland Cavaliers-Los Angeles Lakers, 10:30 PM EST game.

In some embodiments, the interactive media guidance application receives, in the data structure, a fourth field corresponding to a game portion in the real-life sporting event corresponding to the action. For example, the interactive media guidance application may receive a data structure that includes a game portion field in addition to an action description field and a real-life sporting event identifier field. The game portion field may provide pertinent details about the action. Following from the previous example, the interactive media guidance application may further receive in the record the field “LeBron James scored a dunk shot, 9:00-11:00 minutes” which corresponds to a game portion in the real-life sporting event (“Apr. 19, 2016 Cleveland Cavaliers-Los Angeles Lakers, 10:30 PM EST”) corresponding to the action (“dunk shot 10 minutes into the game”).

In some embodiments, the interactive media guidance application parses the metadata to determine game portions in each of the media assets. For example, the interactive media guidance application may parse the metadata of media asset 1, media asset 2 and media asset 3 using processes described previously to extract metadata describing the content of these media assets. The interactive media guidance application may determine that content description metadata associated with media asset 3 is “Nick Young scored a dunk shot at 2:00-4:00 minutes,” “Nick Young performed a steal at 6:50-7:45 minutes” and “LeBron James scored a dunk shot at 9:00-11:00 minutes.”

In some embodiments, the interactive media guidance application compares game portions to the game portion to determine the media asset of the media assets corresponding to the real-life sporting event. For example, interactive media guidance application may use a Boolean comparison function to compare game portions extracted from the metadata of the media assets (e.g., “Nick Young scored a dunk shot at 2:00-4:00 minutes,” “Nick Young performed a steal at 6:50-7:45 minutes” and “LeBron James scored a dunk shot at 9:00-11:00 minutes”) with the game portion received in the record “LeBron James scored a dunk shot, 9:00-11:00 minutes”) to determine if there is a match. In this instance, the Boolean comparison function returns a “true” result when game portions from the metadata of media asset 3 are compared to the game portion received in the data structure.

Based on this result, the interactive media guidance application can determine that media asset 3 corresponds to the Apr. 19, 2016 Cleveland Cavaliers-Los Angeles Lakers, 10:30 PM EST game.

In some embodiments, the interactive media guidance application determines that content source providing the media asset requires authentication credential. Authentication credential (e.g., user name, password) is an unique identifier associated with the user such as a string of characters or bio-metric data (e.g., finger print, retina scan, voice recognition or another suitable bio-metric data). The interactive media guidance application may receive a communication from the content source via communications network 814 that authentication credential are required when the interactive media guidance application initiates the process to generate for display the portion of the media asset corresponding to the action. Alternatively, the interactive media guidance application may access a database associated with the content source, located at any of storage media content source 816 and media guidance data source 818, prior to accessing the media asset to determine whether the content source requires authentication credential. For example, the interactive media guidance application may determine that in order to access media asset 3 from the OTT source 1, a user password has to be provided to OTT source 1.

In some embodiments, the interactive media guidance application accesses a profile data structure of the user corresponding to the content source to retrieve value of the authentication credential and provides the content source the authentication credential such that the user does not have to manually enter the authentication credential. For example, the interactive media guidance application may access the user profile data structure in the database associated with user's subscription account for OTT source 1, located at any of storage 708, media content source 816 and media guidance data source 818, to retrieve the value of the authentication credential (e.g., password “MW_1986”). The interactive media guidance application may provide the authentication credential (i.e., password “MW_1986”) to the content source without requiring any user intervention so that the user has automated access to the media asset.

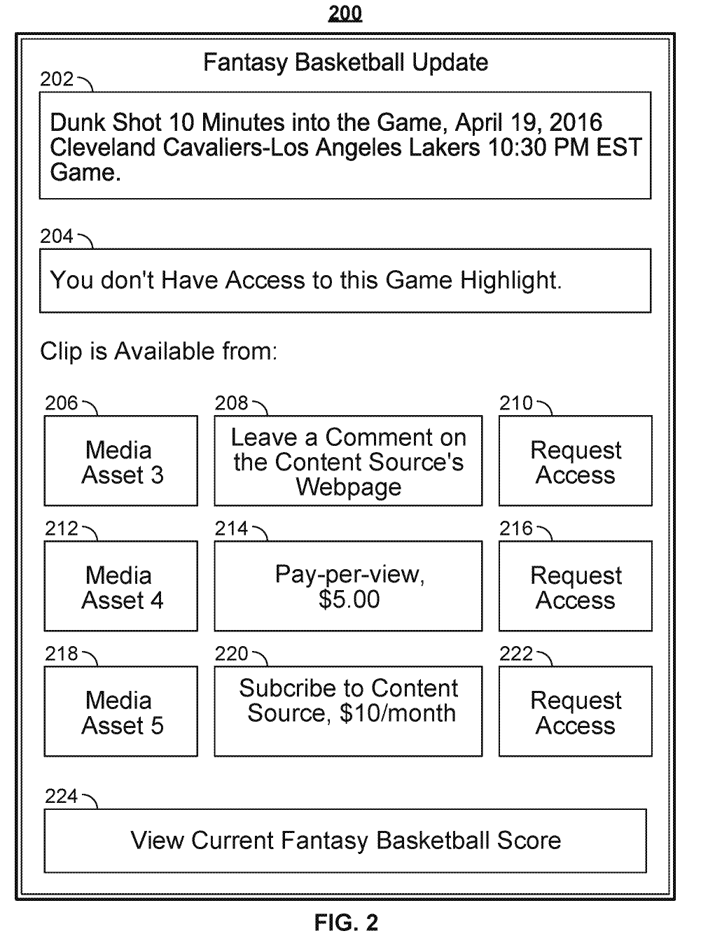

FIG. 2 depicts another illustrative display of the interactive media guidance application in accordance with some embodiments of the disclosure. FIG. 2 depicts an illustrative display 200 which may be displayed on any user device (e.g., user television equipment 802, user computer equipment 804, and wireless user communications device 806, described in FIG. 8 below). The interactive media guidance application may instruct control circuitry 704 to display illustrative display 200 on display 712 using the one or more of the processes described in FIGS. 9-12.

Display 200 is an example of a display that the interactive media guidance application may generate upon determining that the access right for the media asset does not correspond to the access right granted in the user subscription. The interactive media guidance application may generate for display the notification of the action “dunk shot 10 minutes into the game, Apr. 19, 2016 Cleveland Cavaliers-Los Angeles Lakers 10:30 PM EST game” 202 without the portion of the media asset corresponding to the action. For example, the interactive media guidance application may determine that the access right for media asset 3 is that access is granted to all users who have a premier subscription for OTT source 1. The interactive media guidance application may determine, by accessing a database associated with user's subscription account for OTT source 1, that the user has a basic subscription for OTT source 1. In this instance, the interactive media guidance application determines that the two access rights are not identical and generates for display notification “dunk shot 10 minutes into the game, Apr. 19, 2016 Cleveland Cavaliers-Los Angeles Lakers 10:30 PM EST game” 202. In some embodiments, the interactive media guidance application may also generate a notification “You don't have access to this game highlight” 204 to inform the user why the portion of the media asset corresponding to the action is not being displayed simultaneously.

In some embodiments, the interactive media guidance application, upon determining that the access right for the media asset does not correspond to the access right granted in the user subscription, includes in the notification an option to request access to the media asset. For example, the interactive media guidance application may generate for display media asset identifier “Media asset 3” 206 along with an associated selectable option “request access” 210 to allow the user to request access to media asset 3.

In some embodiments, the interactive media guidance application may determine that there are numerous media assets corresponding to the action that the user can request access to. The interactive media guidance application may generate for display media asset identifiers for all the media assets (“Media asset 3” 206, “Media asset 4” 212 and “Media asset 5” 218) along with a selectable option corresponding to each of the media assets (“request access” 210, “request access” 216 and “request access” 222). In some embodiments, the interactive media guidance application may also generate for display the criteria that has to be fulfilled in order to gain access to the media asset. For example, for access to “Media asset 3” 206, the user has to fulfill criterion “leave a comment on the content source's webpage” 208. Similarly, for access to “Media asset 4” 212 and “Media asset 5” 218, the user has to fulfill criteria “Pay-per-view, $5.00” 214 and “Subscribe to content source, $10/month” 220 respectively.

In some embodiments, the interactive media guidance application organizes the available media assets corresponding to the real-life sporting event according to a ranking criteria. The interactive media guidance application may use a sorting algorithm (e.g., quicksort, heapsort, mergesort or another suitable algorithm) to organize the media assets according to the ranking criteria. As depicted in FIG. 2, the interactive media guidance application may organize the available media assets (“Media asset 3” 206, “Media asset 4” 212 and “Media asset 5” 218) according to cost (“leave a comment on the content source's webpage” 208, “Pay-per-view, $5.00” 214, “Subscribe to content source, $10/month” 220) such that the media asset with the lowest cost is listed first.

In some embodiments, the interactive media guidance application includes in the notification an option to view the fantasy sports score of the user. For example, the interactive media guidance application generate for display the selectable option “View current fantasy basketball score” 224 to allow the user to indicate a desire to view the current score. The interactive media guidance application may, in response to receiving user selection of the option “View current fantasy basketball score” 224 via user input interface 710, retrieve a value corresponding to the fantasy sports score from a data structure corresponding to a fantasy sports team of the user. The interactive media guidance application may generate for display the fantasy sports score of the user. For example, the interactive media guidance application may access a data structure associated with the user's fantasy basketball team, located at any of storage 708, media content source 816 and media guidance data source 818, to retrieve the current value (e.g., 50) of the user's fantasy basketball score. The interactive media guidance application may then generate for display a prompt such as “Your current score is 50” to inform the user of the current score.

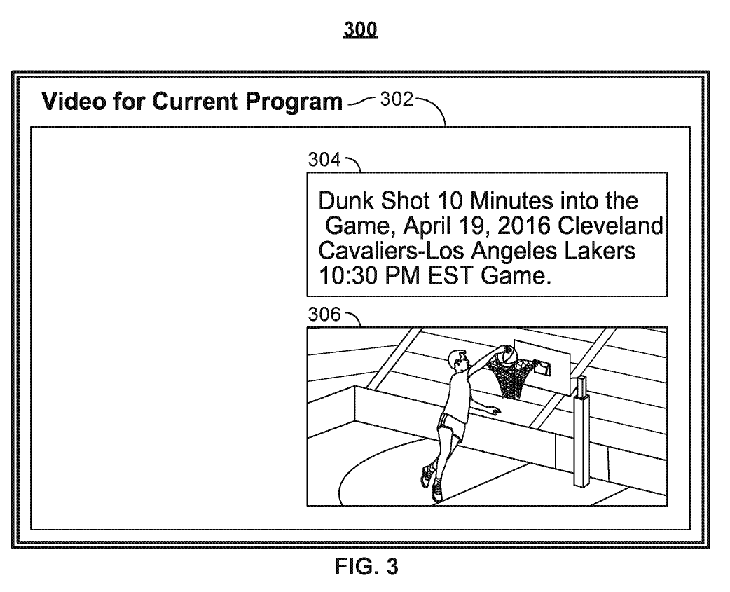

FIG. 3 depicts yet another illustrative display of the interactive media guidance application in accordance with some embodiments of the disclosure. FIG. 3 depicts illustrative display 300 which may be displayed on any user device (e.g., user television equipment 802, user computer equipment 804, and wireless user communications device 806, described in FIG. 8 below). The interactive media guidance application may instruct control circuitry 704 to display illustrative display 300 on display 712 using the one or more of the processes described in FIGS. 9-12.

As depicted in display 300, the interactive media guidance application may display the notification “dunk shot 10 minutes into the game, Apr. 19, 2016 Cleveland Cavaliers-Los Angeles Lakers 10:30 PM EST game” 304 and a portion of the media asset corresponding to the action 306 simultaneously with a program currently being displayed “video for current program” 302. The interactive media guidance application may use a variety of display formats (e.g., overlay, banner, picture-in-picture (“PIP”) and other suitable display formats)for the simultaneous display of the notification, the portion of the media asset corresponding to the action and the current program. For example, the interactive media guidance application may display the notification as an overlay over either or both the portion of the media asset corresponding to the action and the program currently being displayed. Alternatively, the interactive media guidance application may display the three items in three non-overlapping areas.

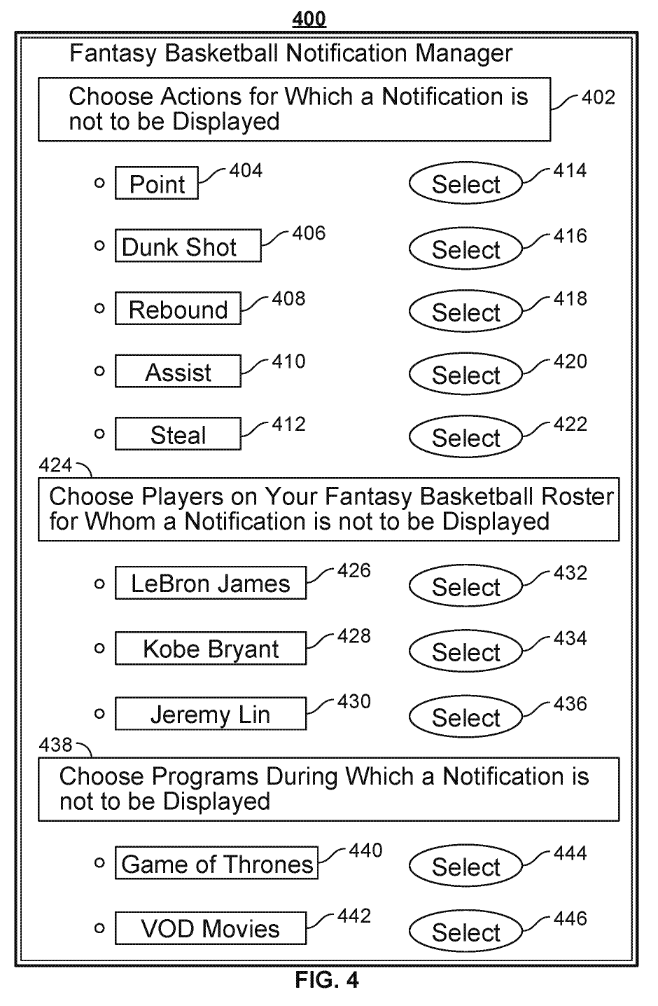

FIG. 4 depicts yet another illustrative display of the interactive media guidance application in accordance with some embodiments of the disclosure. FIG. 4 depicts illustrative display 400 which may be displayed on any user device (e.g., user television equipment 802, user computer equipment 804, and wireless user communications device 806, described in FIG. 8 below). The interactive media guidance application may instruct control circuitry 704 to display illustrative display 400 on display 712 using the one or more of the processes described in FIGS. 9-12.

In some embodiments, the interactive media guidance application receives a user selection of actions in real-life sporting events that affect the fantasy sports score of the user for which the notification and the portion of the media asset corresponding to the action are not to be displayed. For example, as shown in display 400, the interactive media guidance application may generate for display the prompt “Choose actions for which a notification is not to be displayed” 402 along with action descriptors (“Point” 404, “dunk shot” 406, “Rebound” 408, “Assist” 410 and “Steal” 412) and a selectable option corresponding to each of the action descriptors (“Select” 414 corresponding to “Point” 404; “Select” 416 corresponding to “dunk shot” 406; “Select” 418 corresponding to “Rebound” 408; “Select” 420 corresponding to “Assist” 410 and “Select” 422 corresponding to “Steal” 412).

Upon receiving user selection of any of the selectable options (“Select” 414, “Select” 416, “Select” 418, “Select” 420 and “Select” 422) via user input interface 710, the interactive media guidance application may store a field corresponding to the action descriptor associated with that selectable option in a data structure (e.g., “no notification action list”) located at any of storage 708, media content source 816 and media guidance data source 818. For example, upon receiving user selection of options “Select” 416 and “Select” 420, the interactive media guidance application may store fields corresponding to action descriptors “dunk shot” 406 and “Assist” 410 in the “no notification action list.”

In some embodiments, the interactive media guidance application determines that the action is included in the user selection of actions by comparing the first field corresponding to the action to fields corresponding to the user selection of action. In response to the determining, the interactive media guidance application does not generate for display the notification and the portion of the media asset corresponding to the action. For example, the interactive media guidance application may use a Boolean comparison function to compare the first field (e.g., dunk shot 10 minutes into the game) with the fields corresponding to action descriptors (e.g., fields corresponding to action descriptors “dunk shot” 406 and “Assist” 410) stored in the “no notification action list” data structure. In this instance, the interactive media guidance application determines that the action is included in the user selection of actions based on a “true” result from the Boolean comparison function and does not generate for display the notification and the portion of the media asset corresponding to the action.

In some embodiments, the interactive media guidance application receives a user selection of real-life sports player on the user's fantasy team roster for whom the notification and the portion of the media asset corresponding to the action are not to be displayed. For example, for a user participating in a fantasy basketball contest, the interactive media guidance application may include in display 400 a prompt such as “Choose players on your fantasy basketball roster for whom a notification is not to be displayed” 424. The interactive media guidance application may also generate for display real-life sports player identifiers (e.g., “LeBron James” 426, “Kobe Bryant” 428 and “Jeremy Lin” 430) and a selectable option corresponding to each of the real-life sports player identifiers (e.g., “Select” 432 corresponding to “LeBron James” 426; “Select” 434 corresponding to “Kobe Bryant” 428; “Select” 436 corresponding to “Jeremy Lin” 430) for receiving the user selection of the real-life sports players.

For example, the user may indicate that the user does not wish to be notified of any action performed by real-life sports player “LeBron James” 426 by selecting selectable option “Select” 432. The interactive media guidance application may store fields corresponding to the user selection of real-life sports players on the user's fantasy team roster in a data structure (e.g., “no notification sports players list”) located at any of storage 708, media content source 816 and media guidance data source 818. The interactive media guidance application may compare the third field with the fields in the “no notification sports players list” to determine whether the notification and the portion of the media asset corresponding to the action are to be displayed, using processes similar to the ones described previously.

In some embodiments, the interactive media guidance application receives a user selection of programs during which the notification and the portion of the media asset corresponding to the action are not to be displayed. For example, the interactive media guidance application may include in display 400 a prompt such as “Choose programs during which a notification is not to be displayed” 438. The interactive media guidance application may also generate for display program identifiers (e.g., “Game of Thrones” 440, “VOD movies” 442) and a selectable option corresponding to each of these program identifiers (e.g., “Select” 444 corresponding to “Game of Thrones” 440; “Select” 446 corresponding to “VOD movies” 442) for receiving the user selection of the programs.

For example, the interactive media guidance application may receive a user selection of the “select” 444 option corresponding to the program identifier “Game of Thrones” 440, indicating that a notification is not be displayed when the program “Game of Thrones” is being displayed. In some embodiments, the interactive media guidance application, upon receiving user selection of programs during which the notification is not to be displayed, stores the program identifiers (e.g., “Game of Thrones” 440) corresponding to the user selection of programs in a data structure (e.g., “no notification program list”) located at any of storage 708, media content source 816 and media guidance data source 818.

In some embodiments, the interactive media guidance application parses metadata corresponding to the program currently being displayed to determine an identifier of the program (e.g., program name, program serial code or any other suitable identifier) currently being displayed using processes described previously. The interactive media guidance application may compare the identifier of the program currently being displayed with identifiers of programs during which the notification is not to be displayed to determine whether the notification is to be displayed simultaneously with the current program. For example, the interactive media guidance application may use a Boolean comparison function to compare the program identifier of the program currently being displayed with the program identifiers (“Game of Thrones” 440) stored in the “no notification program list” data structure. The interactive media guidance application may determine, upon receiving a “true” result from the Boolean comparison function, that the program currently being displayed is included in the selection of programs during which the notification is not to be displayed.

The interactive media guidance application may, upon determining that the program currently being displayed is included in the selection of programs, not generate for display the notification and the portion of the media asset corresponding to the action. From the previous example, while the program “Game of Thrones” is being displayed, the interactive media guidance application does not generate for display the notification and the portion of the media asset corresponding to the action.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

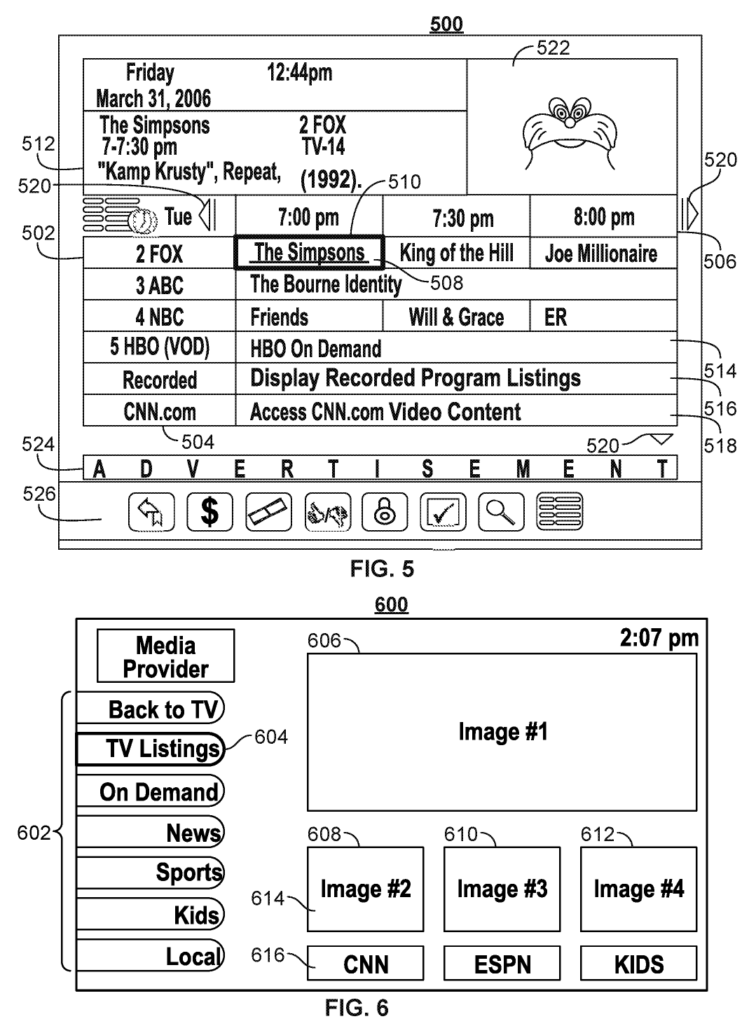

FIGS. 5-6 show illustrative display screens that may be used to provide media guidance data. The display screens shown in FIGS. 5-6 may be implemented on any suitable user equipment device or platform. While the displays of FIGS. 5-6 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 5 shows illustrative grid of a program listings display 500 arranged by time and channel that also enables access to different types of content in a single display. Display 500 may include grid 502 with: (1) a column of channel/content type identifiers 504, where each channel/content type identifier (which is a cell in the column) identifies a different channel or content type available; and (2) a row of time identifiers 506, where each time identifier (which is a cell in the row) identifies a time block of programming. Grid 502 also includes cells of program listings, such as program listing 508, where each listing provides the title of the program provided on the listing's associated channel and time. With a user input device, a user can select program listings by moving highlight region 510. Information relating to the program listing selected by highlight region 510 may be provided in program information region 512. Region 512 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company, L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 502 may provide media guidance data for non-linear programming including on-demand listing 514, recorded content listing 516, and Internet content listing 518. A display combining media guidance data for content from different types of content sources is sometimes referred to as a “mixed-media” display. Various permutations of the types of media guidance data that may be displayed that are different than display 500 may be based on user selection or guidance application definition (e.g., a display of only recorded and broadcast listings, only on-demand and broadcast listings, etc.). As illustrated, listings 514, 516, and 518 are shown as spanning the entire time block displayed in grid 502 to indicate that selection of these listings may provide access to a display dedicated to on-demand listings, recorded listings, or Internet listings, respectively. In some embodiments, listings for these content types may be included directly in grid 502. Additional media guidance data may be displayed in response to the user selecting one of the navigational icons 520. (Pressing an arrow key on a user input device may affect the display in a similar manner as selecting navigational icons 520.)

Display 500 may also include video region 522, advertisement 524, and options region 526. Video region 522 may allow the user to view and/or preview programs that are currently available, will be available, or were available to the user. The content of video region 522 may correspond to, or be independent from, one of the listings displayed in grid 502. Grid displays including a video region are sometimes referred to as picture-in-guide (PIG) displays. PIG displays and their functionalities are described in greater detail in Satterfield et al. U.S. Patent No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 524 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 502. Advertisement 524 may also be for products or services related or unrelated to the content displayed in grid 502.

Advertisement 524 may be selectable and provide further information about content, provide information about a product or a service, enable purchasing of content, a product, or a service, provide content relating to the advertisement, etc. Advertisement 524 may be targeted based on a user's profile/preferences, monitored user activity, the type of display provided, or on other suitable targeted advertisement bases.

While advertisement 524 is shown as rectangular or banner shaped, advertisements may be provided in any suitable size, shape, and location in a guidance application display. For example, advertisement 524 may be provided as a rectangular shape that is horizontally adjacent to grid 502. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 526 may allow the user to access different types of content, media guidance application displays, and/or media guidance application features. Options region 526 may be part of display 500 (and other display screens described herein), or may be invoked by a user by selecting an on-screen option or pressing a dedicated or assignable button on a user input device. The selectable options within options region 526 may concern features related to program listings in grid 502 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the

Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 8. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 6. Video mosaic display 600 includes selectable options 602 for content information organized based on content type, genre, and/or other organization criteria. In display 600, television listings option 604 is selected, thus providing listings 606, 608, 610, and 612 as broadcast program listings. In display 600 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 608 may include more than one portion, including media portion 614 and text portion 616. Media portion 614 and/or text portion 616 may be selectable to view content in full-screen or to view information related to the content displayed in media portion 614 (e.g., to view listings for the channel that the video is displayed on).

The listings in display 600 are of different sizes (i.e., listing 606 is larger than listings 608, 610, and 612), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

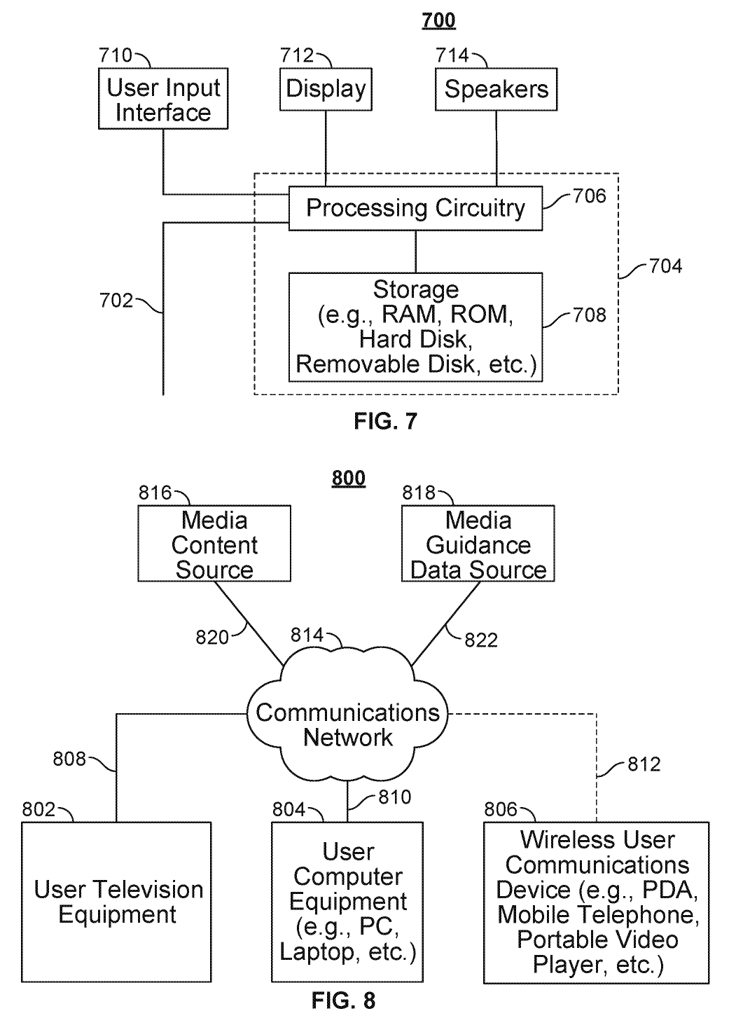

Users may access content and the media guidance application (and its display screens described above and below) from one or more of their user equipment devices. FIG. 7 shows a generalized embodiment of illustrative user equipment device 700. More specific implementations of user equipment devices are discussed below in connection with FIG. 8. User equipment device 700 may receive content and data via input/output (hereinafter “I/O”) path 702. I/O path 702 may provide content (e.g., broadcast programming, on-demand programming, Internet content, content available over a local area network (LAN) or wide area network (WAN), and/or other content) and data to control circuitry 704, which includes processing circuitry 706 and storage 708. Control circuitry 704 may be used to send and receive commands, requests, and other suitable data using I/O path 702. I/O path 702 may connect control circuitry 704 (and specifically processing circuitry 706) to one or more communications paths (described below). I/O functions may be provided by one or more of these communications paths, but are shown as a single path in FIG. 7 to avoid overcomplicating the drawing.

Control circuitry 704 may be based on any suitable processing circuitry such as processing circuitry 706. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 704 executes instructions for a media guidance application stored in memory (i.e., storage 708). Specifically, control circuitry 704 may be instructed by the media guidance application to perform the functions discussed above and below. For example, the media guidance application may provide instructions to control circuitry 704 to generate the media guidance displays. In some implementations, any action performed by control circuitry 704 may be based on instructions received from the media guidance application.

In client-server based embodiments, control circuitry 704 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 8). In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as media guidance data described above. Nonvolatile memory may also be used (e.g., to launch a boot-up routine and other instructions). Cloud-based storage, described in relation to FIG. 8, may be used to supplement storage 708 or instead of storage 708.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of the user equipment 700. Circuitry 704 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 708 is provided as a separate device from user equipment 700, the tuning and encoding circuitry (including multiple tuners) may be associated with storage 708.

A user may send instructions to control circuitry 704 using user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of user equipment device 700. For example, display 712 may be a touchscreen or touch-sensitive display. In such circumstances, user input interface 710 may be integrated with or combined with display 712. Display 712 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 712 may be HDTV-capable. In some embodiments, display 712 may be a 3D display, and the interactive media guidance application and any suitable content may be displayed in 3D. A video card or graphics card may generate the output to the display 712. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 704. The video card may be integrated with the control circuitry 704. Speakers 714 may be provided as integrated with other elements of user equipment device 700 or may be stand-alone units. The audio component of videos and other content displayed on display 712 may be played through speakers 714. In some embodiments, the audio may be distributed to a receiver (not shown), which processes and outputs the audio via speakers 714.

The guidance application may be implemented using any suitable architecture. For example, it may be a stand-alone application wholly-implemented on user equipment device 700. In such an approach, instructions of the application are stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to generate any of the displays discussed herein. Based on the processed instructions, control circuitry 704 may determine what action to perform when input is received from input interface 710. For example, movement of a cursor on a display up/down may be indicated by the processed instructions when input interface 710 indicates that an up/down button was selected.

In some embodiments, the media guidance application is a client-server based application. Data for use by a thick or thin client implemented on user equipment device 700 is retrieved on-demand by issuing requests to a server remote to the user equipment device 700. In one example of a client-server based guidance application, control circuitry 704 runs a web browser that interprets web pages provided by a remote server. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on equipment device 700. This way, the processing of the instructions is performed remotely by the server while the resulting displays are provided locally on equipment device 700. Equipment device 700 may receive inputs from the user via input interface 710 and transmit those inputs to the remote server for processing and generating the corresponding displays. For example, equipment device 700 may transmit a communication to the remote server indicating that an up/down button was selected via input interface 710. The remote server may process instructions in accordance with that input and generate a display of the application corresponding to the input (e.g., a display that moves a cursor up/down). The generated display is then transmitted to equipment device 700 for presentation to the user.

In some embodiments, the media guidance application is downloaded and interpreted or otherwise run by an interpreter or virtual machine (run by control circuitry 704). In some embodiments, the guidance application may be encoded in the ETV Binary Interchange Format (EBIF), received by control circuitry 704 as part of a suitable feed, and interpreted by a user agent running on control circuitry 704. For example, the guidance application may be an EBIF application. In some embodiments, the guidance application may be defined by a series of JAVA-based files that are received and run by a local virtual machine or other suitable middleware executed by control circuitry 704. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 700 of FIG. 7 can be implemented in system 800 of FIG. 8 as user television equipment 802, user computer equipment 804, wireless user communications device 806, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 7 may not be classified solely as user television equipment 802, user computer equipment 804, or a wireless user communications device 806. For example, user television equipment 802 may, like some user computer equipment 804, be Internet-enabled allowing for access to Internet content, while user computer equipment 804 may, like some user television equipment 802, include a tuner allowing for access to television programming. The media guidance application may have the same layout on various different types of user equipment or may be tailored to the display capabilities of the user equipment. For example, on user computer equipment 804, the guidance application may be provided as a web site accessed by a web browser. In another example, the guidance application may be scaled down for wireless user communications devices 806.

In system 800, there is typically more than one of each type of user equipment device but only one of each is shown in FIG. 8 to avoid overcomplicating the drawing. In addition, each user may utilize more than one type of user equipment device and also more than one of each type of user equipment device.

In some embodiments, a user equipment device (e.g., user television equipment 802, user computer equipment 804, wireless user communications device 806) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 814. Namely, user television equipment 802, user computer equipment 804, and wireless user communications device 806 are coupled to communications network 814 via communications paths 808, 810, and 812, respectively. Communications network 814 may be one or more networks including the Internet, a mobile phone network, mobile voice or data network (e.g., a 4G or LTE network), cable network, public switched telephone network, or other types of communications network or combinations of communications networks. Paths 808, 810, and 812 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 812 is drawn with dotted lines to indicate that in the exemplary embodiment shown in FIG. 8 it is a wireless path and paths 808 and 810 are drawn as solid lines to indicate they are wired paths (although these paths may be wireless paths, if desired). Communications with the user equipment devices may be provided by one or more of these communications paths, but are shown as a single path in FIG. 8 to avoid overcomplicating the drawing.

Although communications paths are not drawn between user equipment devices, these devices may communicate directly with each other via communication paths, such as those described above in connection with paths 808, 810, and 812, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 814.

System 800 includes content source 816 and media guidance data source 818 coupled to communications network 814 via communication paths 820 and 822, respectively. Paths 820 and 822 may include any of the communication paths described above in connection with paths 808, 810, and 812. Communications with the content source 816 and media guidance data source 818 may be exchanged over one or more communications paths, but are shown as a single path in FIG. 8 to avoid overcomplicating the drawing. In addition, there may be more than one of each of content source 816 and media guidance data source 818, but only one of each is shown in FIG. 8 to avoid overcomplicating the drawing. (The different types of each of these sources are discussed below.) If desired, content source 816 and media guidance data source 818 may be integrated as one source device. Although communications between sources 816 and 818 with user equipment devices 802, 804, and 806 are shown as through communications network 814, in some embodiments, sources 816 and 818 may communicate directly with user equipment devices 802, 804, and 806 via communication paths (not shown) such as those described above in connection with paths 808, 810, and 812.

Content source 816 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 816 may be the originator of content (e.g., a television broadcaster, a Webcast provider, etc.) or may not be the originator of content (e.g., an on-demand content provider, an Internet provider of content of broadcast programs for downloading, etc.). Content source 816 may include cable sources, satellite providers, on-demand providers, Internet providers, over-the-top content providers, or other providers of content. Content source 816 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 818 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 818 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 818 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 818 may provide user equipment devices 802, 804, and 806 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 708, and executed by control circuitry 704 of a user equipment device 700. In some embodiments, media guidance applications may be client-server applications where only a client application resides on the user equipment device, and server application resides on a remote server. For example, media guidance applications may be implemented partially as a client application on control circuitry 704 of user equipment device 700 and partially on a remote server as a server application (e.g., media guidance data source 818) running on control circuitry of the remote server. When executed by control circuitry of the remote server (such as media guidance data source 818), the media guidance application may instruct the control circuitry to generate the guidance application displays and transmit the generated displays to the user equipment devices. The server application may instruct the control circuitry of the media guidance data source 818 to transmit data for storage on the user equipment. The client application may instruct control circuitry of the receiving user equipment to generate the guidance application displays.

Content and/or media guidance data delivered to user equipment devices 802, 804, and 806 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 800 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 8.

In one approach, user equipment devices may communicate with each other within a home network. User equipment devices can communicate with each other directly via short-range point-to-point communication schemes described above, via indirect paths through a hub or other similar device provided on a home network, or via communications network 814. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 816 to access content. Specifically, within a home, users of user television equipment 802 and user computer equipment 804 may access the media guidance application to navigate among and locate desirable content. Users may also access the media guidance application outside of the home using wireless user communications devices 806 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 814. These cloud resources may include one or more content sources 816 and one or more media guidance data sources 818. In addition or in the alternative, the remote computing sites may include other user equipment devices, such as user television equipment 802, user computer equipment 804, and wireless user communications device 806. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 804 or wireless user communications device 806 having content capture feature. Alternatively, the user can first transfer the content to a user equipment device, such as user computer equipment 804. The user equipment device storing the content uploads the content to the cloud using a data transmission service on communications network 814. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 7.

As referred herein, the term “in response to” refers to initiated as a result of For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

FIG. 9 is a flowchart of illustrative steps involved in providing a user access a media asset associated with an action that affects the user's fantasy sports score in accordance with some embodiments of the disclosure. Process 900 may be used to determine whether a user has access to a media asset associated with an action that affects the user's fantasy sports score. It should be noted that process 900 or any step thereof could be performed on, or provided by, any of the devices shown in FIGS. 7-8. For example, process 900 may be executed by control circuitry 704 (FIG. 7) as instructed by the interactive media guidance application implemented on user equipment 802, 804, and/or 806 (FIG. 8). In addition, one or more steps of process 900 may be incorporated into or combined with one or more steps of any other process or embodiment.

Process 900 begins at 902, where control circuitry 704 receives a data structure that includes a first field corresponding to an action in a real-life sporting event that affects a fantasy sports score of a user and a second field corresponding to an identification of the real-life sporting event corresponding to the action. For example, control circuitry 704 receives a record with fields “dunk shot 10 minutes into the game” and “Apr. 19, 2016 Cleveland Cavaliers-Los Angeles Lakers, 10:30 PM EST.” Process 900 continues to 904, where control circuitry 704 retrieves metadata corresponding to media assets provided by a plurality of content sources. For example, control circuitry 704 may query content listings databases of the plurality of content sources located at media content source 816 and media guidance data source 818 for media assets associated with live real-life sporting events. Control circuitry 704 may access data structures associated with each of the media assets for the associated metadata. Manners in which control circuitry 704 may perform this retrieval discussed previously are applicable here. For example, control circuitry 704 may determine that media asset 1, media asset 2 and media asset 3 are all media assets associated with real-life basketball games and retrieve metadata corresponding to these media assets.

Process 900 continues to 906, where control circuitry 704 parses the metadata to determine real-life sporting events in each of the media assets.

Manners in which control circuitry 704 may perform this determination discussed previously are applicable here. For example, by parsing the metadata for media asset 1, the interactive media guidance application may determine that the real-life sporting event corresponding to media asset 1 is the “Apr. 19, 2016 Golden State Warriors-Chicago Bulls game, 10:00 PM EST game.” Similarly, the interactive media guidance application may determine that the real-life sporting events corresponding to the media asset 2 and media asset 3 are the “Apr. 19, 2016 Miami Heat-Dallas Mavericks, 9:55 PM EST game” and the “Apr. 19, 2016 Cleveland Cavaliers-Los Angeles Lakers, 10:30 PM EST game” respectively.

Process 900 continues to 908, where control circuitry 704 compares the real-life sporting events to the real-life sporting event to determine a media asset of the media assets corresponding to the real-life sporting event.

Process 900 continues to 910, where control circuitry 704 determines if there is a media asset corresponding to the real-life sporting event. Manners in which control circuitry 704 may perform this determination discussed above and below are applicable here.

If, at 910, control circuitry 704 determines that there is a media asset corresponding to the real-life sporting event, process 900 continues to 912. At 912, control circuitry 704 determines an access right for the media asset. For example, control circuitry 704 may determine that media asset 3 corresponds to the real-life sporting event and the access right for media asset 3 is access is granted to all users who have a subscription for content source providing media asset 3 (e.g., OTT source 1). From 912, process 900 continues to 914 where control circuitry 704 compares the access right for the media asset to an access right granted in a user subscription. For example, the interactive media guidance application may access a database associated with user's subscription account for OTT source 1 to determine access right granted to the user for content from OTT source 1. Process 900 continues to 916 where control circuitry 704 determines whether the access right for the media asset corresponds to the access right granted in the user subscription. Manners in which control circuitry 704 may perform this determination discussed above and below are applicable here.

If, at 916, control circuitry 704 determines that the access right for the media asset corresponds to the access right granted in the user subscription, process 900 continues to 918. At 918, control circuitry 704 generates for display a notification that the action has occurred simultaneously with a portion of the media asset corresponding to the action. For example, control circuitry 704 may generate for display a notification 102 that says “dunk shot 10 minutes into the game, Apr. 19, 2016 Cleveland Cavaliers-Los Angeles Lakers 10:30 PM EST game” simultaneously with a portion of media asset 3 corresponding to the action 104. If, at 910, control circuitry 704 determines that there is no media asset corresponding to the real-life sporting event, process 900 continues to 920. Similarly if, at 916, control circuitry 704 determines that the access right for the media asset does not correspond to the access right granted in the user subscription, process 900 continues to 920. At 920, the process terminates

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

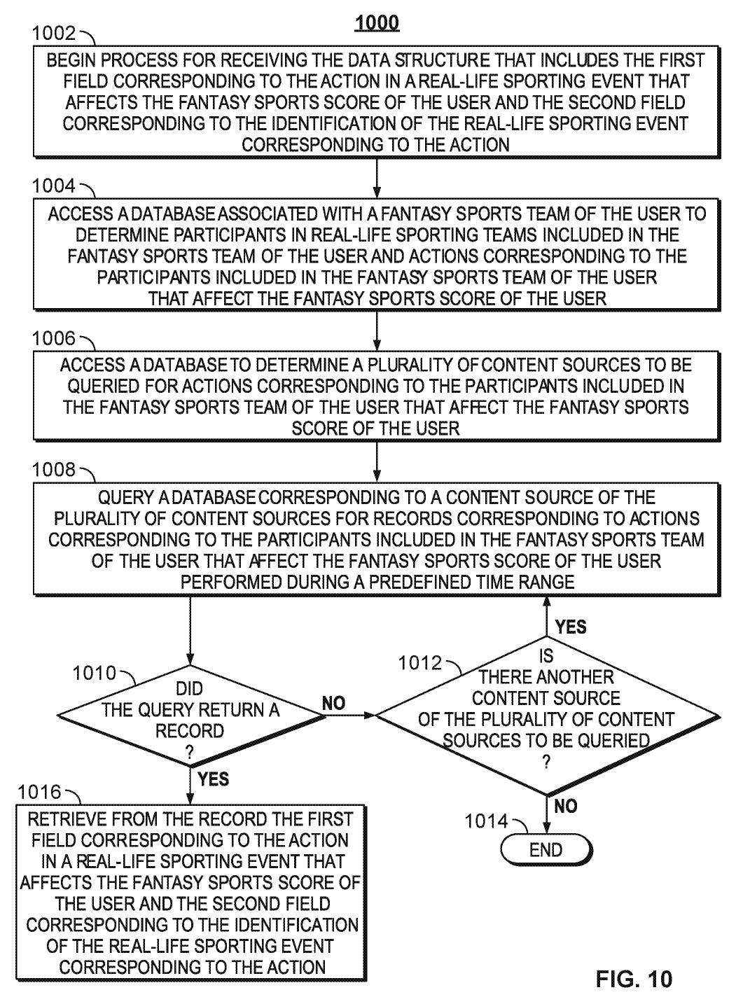

FIG. 10 is a flowchart of illustrative steps involved in step 902 (FIG. 9) when receiving the data structure that includes the first field corresponding to the action in a real-life sporting event that affects the fantasy sports score of the user and the second field corresponding to the identification of the real-life sporting event corresponding to the action in accordance with some embodiments of the disclosure. Process 1000 may be used to retrieve the first field and the second field. It should be noted that process 1000 or any step thereof could be performed on, or provided by, any of the devices shown in FIGS. 7-8. For example, process 1000 may be executed by control circuitry 704 (FIG. 7) as instructed by the interactive media guidance application implemented on user equipment 802, 804, and/or 806 (FIG. 8). In addition, one or more steps of process 1000 may be incorporated into or combined with one or more steps of any other process or embodiment.

Process 1000 begins at 1002 where control circuitry 704 begins process for receiving the data structure that includes the first field corresponding to the action in a real-life sporting event that affects the fantasy sports score of the user and the second field corresponding to the identification of the real-life sporting event corresponding to the action. Control circuitry 704 may execute 1002 when 902 of process 900 begins. Process 1000 continues to 1004 where control circuitry 704 accesses a database associated with a fantasy sports team of the user to determine participants in real-life sporting teams included in the fantasy sports team of the user and actions corresponding to the participants included in the fantasy sports team of the user that affect the fantasy sports score of the user. For example, control circuitry 704 may access a data structure associated with the user's fantasy basketball team, located at any of storage 708, media content source 816 and media guidance data source 818, to retrieve real-life sports players on the user's fantasy team roster (e.g., “LeBron James” 426, “Kobe Bryant” 428 and “Jeremy Lin” 430) and actions performed by these players that affect the fantasy sports score of the user (e.g., “Point” 404, “dunk shot” 406, “Rebound” 408, “Assist” 410 and “Steal” 412).

Process 1000 continues to 1006 where control circuitry 704 accesses a database to determine a plurality of content sources to be queried for actions corresponding to the participants included in the fantasy sports team of the user that affect the fantasy sports score of the user.

Process 1000 continues to 1008 where control circuitry 704 queries a database corresponding to a content source of the plurality of content sources for records corresponding to actions corresponding to the participants included in the fantasy sports team of the user that affect the fantasy sports score of the user performed during a pre-defined time period. For example, control circuitry 704 may query for actions performed by players on the user's fantasy sports team in events that are currently live. Manners in which control circuitry 1204 may perform this querying discussed previously are applicable here.

Process 1000 continues to 1010 where control circuitry 704 determines whether the query returned a record. If, at 1010, control circuitry 704 determines that the query returned a record, process 1000 continues to 1016. At 1016, control circuitry 704 retrieves from the record the first field corresponding to the action in a real-life sporting event that affects the fantasy sports score of the user and the second field corresponding to the identification of the real-life sporting event corresponding to the action. For example, control circuitry 704 may retrieve from the record fields “dunk shot 10 minutes into the game” and “Apr. 19, 2016 Cleveland Cavaliers-Los Angeles Lakers, 10:30 PM EST.” If, at 1010, control circuitry 704 determines that the query did not return a record, process 1000 continues to 1012 where control circuitry 704 determines if there is another content source of the plurality of content sources to be queried. If, at 1012, control circuitry 704 determines that there is another content source of the plurality of content sources to be queried, process 1000 reverts to 1008. If, at 1012, control circuitry 704 determines that there isn't another content source of the plurality of content sources to be queried, process 1000 continues to 1014 where it terminates.

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method.

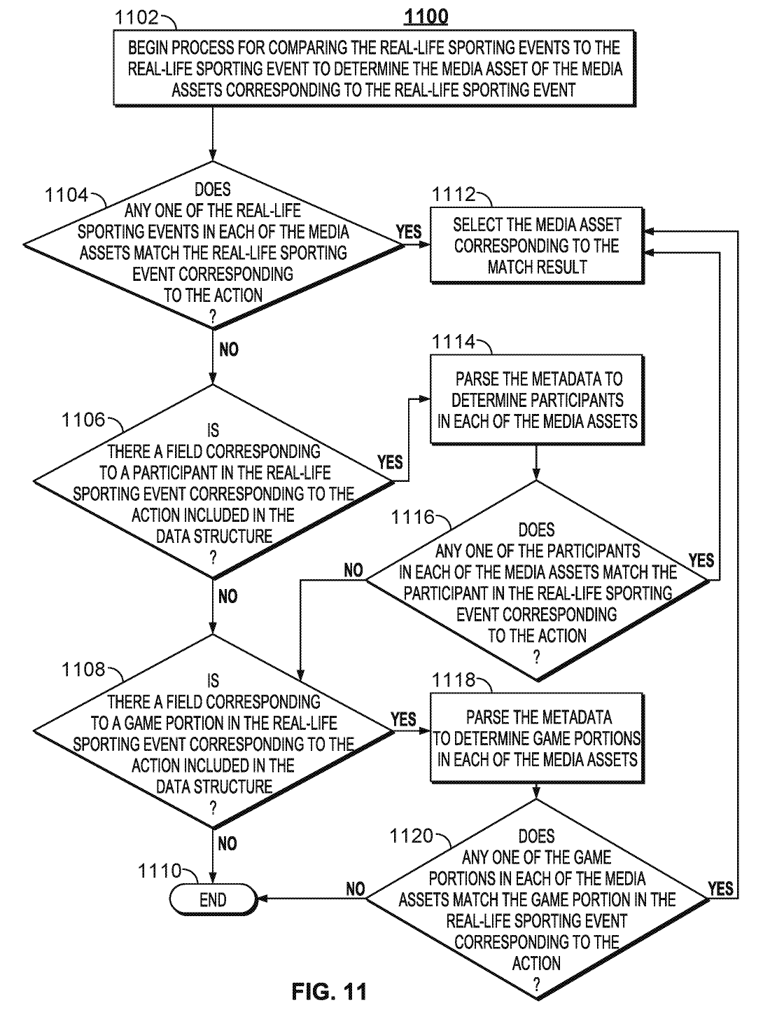

FIG. 11 is a flowchart of illustrative steps involved in step 908 (FIG. 9) when comparing the real-life sporting events to the real-life sporting event to determine a media asset of the media assets corresponding to the real-life sporting event in accordance with some embodiments of the disclosure. Process 1100 may be used to determine a media asset of the media assets corresponding to the real-life sporting event. It should be noted that process 1100 or any step thereof could be performed on, or provided by, any of the devices shown in FIGS. 7-8. For example, process 1100 may be executed by control circuitry 704 (FIG. 7) as instructed by the interactive media guidance application implemented on user equipment 802, 804, and/or 806 (FIG. 8). In addition, one or more steps of process 1000 may be incorporated into or combined with one or more steps of any other process or embodiment.

Process 1100 begins at 1102 where control circuitry 704 begins process for comparing the real-life sporting events to the real-life sporting event to determine the media asset of the media assets corresponding to the real-life sporting event. Control circuitry 704 may execute 1102 when 908 of process 900 begins. Process 1100 continues to 1104, where control circuitry 704 determines whether any one of the real-life sporting events in each of the media assets matches the real-life sporting event corresponding to the action. For example, the control circuitry 704 may compare the real-life sporting events extracted from the metadata of media asset 1, media asset 2 and media asset 3 (e.g., “Apr. 19, 2016 Golden State Warriors-Chicago Bulls game, 10:00 PM EST game,” “Apr. 19, 2016 Miami Heat-Dallas Mavericks, 9:55 PM EST game,” “Apr. 19, 2016 Cleveland Cavaliers-Los Angeles Lakers, 10:30 PM EST game” respectively) with the real-life sporting event received in the data structure (e.g., “Apr. 19, 2016 Cleveland Cavaliers-Los Angeles Lakers, 10:30 PM EST”) to determine if there is a match.

If, at 1104, control circuitry 704 determines that one of the real-life sporting events in one of the media assets matches the real-life sporting event corresponding to the action, process 1100 continues to 1112. At 1112, control circuitry 704 selects the media asset corresponding to the match result. For example, control circuitry 704 determines there is a match at step 1104 and selects media asset 3 at step 1112. If, at 1104, control circuitry 704 determines that one of the real-life sporting events in one of the media assets does not match the real-life sporting event corresponding to the action, process 1100 continues to 1106. At 1106, control circuitry 704 determines whether there a field corresponding to a participant in the real-life sporting event corresponding to the action included in the data structure. For example, at 1106, control circuitry 704 determines whether the record received includes a third field corresponding to a participant in the real-life sporting event corresponding to the action.

If, at 1106, control circuitry 704 determines there is a field corresponding to a participant in the real-life sporting event corresponding to the action included in the data structure, process 1100 continues to 1114. For example, control circuitry 704 may determine at 1106 that the record includes a real-life sporting event participant field with the value “LeBron James.” At 1114, control circuitry 704 parses the metadata to determine participants in each of the media assets. For example, control circuitry 704 may parse the metadata of media asset 1 and determine that the participants corresponding to media asset 1 are the “Stephen Curry” and “Derrick Rose.” Similarly, control circuitry 704 may determine that the participants corresponding to media asset 2 are “Dwyane Wade” and “David Lee” and the participants corresponding to media asset 3 are “LeBron James” and “Nick Young.” Manners in which control circuitry 704 may parse the metadata to extract the participants in each of the media assets discussed previously are applicable here.

From 1114, process 1100 continues to 1116 where control circuitry 704 determines whether any one of the participants in each of the media assets matches the participant in the real-life sporting event corresponding to the action. For example, control circuitry 704 compares the participants in each of the media assets with the participant in the real-life sporting event using a Boolean comparison function. If, at 1116, control circuitry 704 determines that one of the participants in one of the media assets matches the participant in the real-life sporting event corresponding to the action, process 1110 continues to 1112. At 1112, control circuitry 704 selects the media asset corresponding to the match result. For example, the Boolean comparison function yields a “true” result for “LeBron James” and control circuitry 704 selects the corresponding media asset 3.

If, at 1116, control circuitry 704 determines that none of the participants in any of the media assets matches the participant in the real-life sporting event corresponding to the action, process 1110 continues to 1108. Similarly, process 1110 continues to 1108 if, at 1106, control circuitry 704 determines there isn't a field corresponding to a participant in the real-life sporting event corresponding to the action included in the data structure. At 1108, control circuitry 704 determines whether there is a field corresponding to a game portion in the real-life sporting event corresponding to the action included in the data structure. For example, control circuitry 704 may determine at 1108 that the record received includes a includes a game portion field with the value “LeBron James scored a dunk shot, 9:00-11:00 minutes.” If, at 1108, control circuitry 704 determines there is a field corresponding to a game portion in the real-life sporting event corresponding to the action included in the data structure, process 1100 continues to 1118. At 1118, control circuitry 704 parses the metadata to determine game portions in each of the media assets. For example, control circuitry 704 may determine that content description metadata associated with media asset 3 is “Nick Young scored a dunk shot at 2:00-4:00 minutes,” “Nick Young performed a steal at 6:50-7:45 minutes” and “LeBron James scored a dunk shot at 9:00-11:00 minutes.”

From 1118, process 1100 continues to 1120 where control circuitry 704 determines whether any one of the game portions in each of the media assets matches the game portion in the real-life sporting event corresponding to the action. For example, control circuitry 704 compares the game portions in each of the media assets with the game portion in the real-life sporting event using processes described previously. If, at 1120, control circuitry 704 determines that one of the game portions in one of the media assets matches the game portion in the real-life sporting event corresponding to the action, process 1100 continues to 1112 where control circuitry 704 selects the media asset corresponding to the match result. For example, control circuitry 704 determines that “LeBron James scored a dunk shot at 9:00-11:00 minutes” game portion is the match result and selects the corresponding media asset 3. If, at 1120, control circuitry 704 determines that none of the game portions in any of the media assets matches the game portion in the real-life sporting event corresponding to the action, process 1100 continues to 1110. Similarly, if, at 1108, control circuitry 704 determines there isn't a field corresponding to a game portion in the real-life sporting event corresponding to the action included in the data structure, process 1100 continues to 1110. Process 1100 terminates at 1110.

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, each of these steps may be performed in any order or in parallel or substantially simultaneously to reduce lag or increase the speed of the system or method.

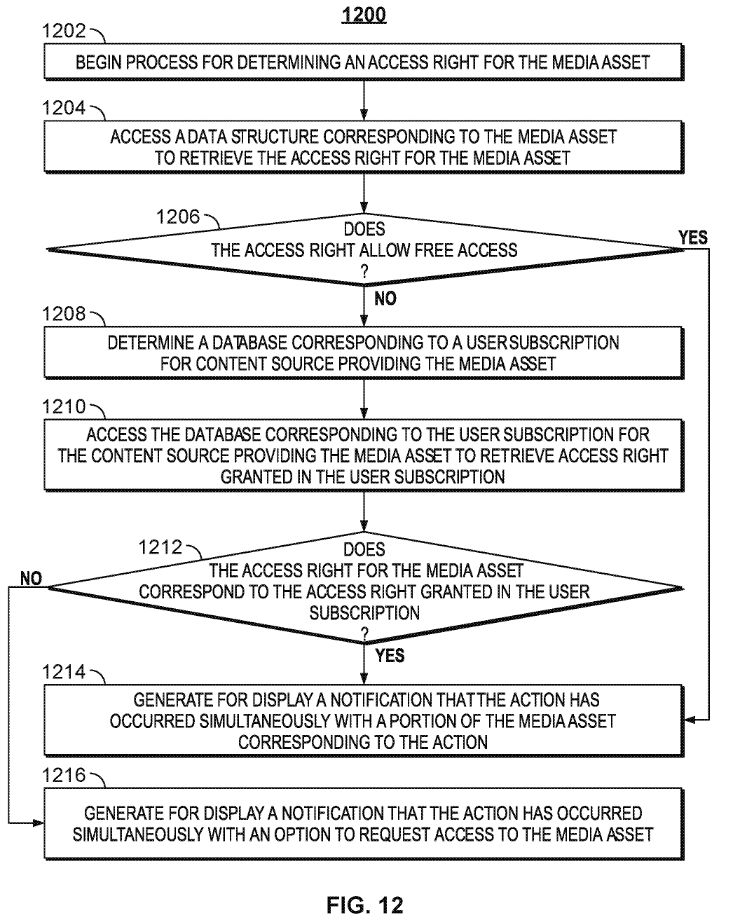

FIG. 12 is a flowchart of illustrative steps involved in step 912 (FIG. 9) when determining an access right for the media asset in accordance with some embodiments of the disclosure. It should be noted that process 1200 or any step thereof could be performed on, or provided by, any of the devices shown in FIGS. 7-8. For example, process 1200 may be executed by control circuitry 704 (FIG. 7) as instructed by the interactive media guidance application implemented on user equipment 802, 804, and/or 806 (FIG. 8). In addition, one or more steps of process 1000 may be incorporated into or combined with one or more steps of any other process or embodiment.

Process 1200 begins at 1202 where control circuitry 704 begins process for determining an access right for the media asset. Process 1200 continues to 1204, where control circuitry 704 accesses a data structure corresponding to the media asset to retrieve the access right for the media asset. For example, control circuitry 704 may determine that media asset 3 corresponds to the real-life sporting event and access a data structure associated with media asset 3 (e.g., a watermark embedded in media asset 3 or an access policy database associated with the content source providing media asset 3 or other suitable data structures) to retrieve the access right for media asset 3.

Process 1200 continues to 1206, where control circuitry 704 determines whether the access right allows free access. For example, control circuitry 704 determines whether the access policy for the media asset is “public.” Control circuitry 704 may also determine from a lack of access right associated with the media asset that the media asset allows free access. If, at 1206, control circuitry 704 determines that the access right allows free access, process 1200 continues to 1214. At 1214, control circuitry 704 generates for display a notification that the action has occurred simultaneously with a portion of the media asset corresponding to the action. For example, control circuitry 704 may generate for display a notification of the action “dunk shot 10 minutes into the game, Apr. 19, 2016 Cleveland Cavaliers-Los Angeles Lakers 10:30 PM EST game” 102 and a portion of the media asset corresponding to the action 104.

If, at 1206, control circuitry 704 determines that the access right does not allow free access, process 1200 continues to 1218. At 1208, control circuitry 704 determines a database corresponding to a user subscription to content source providing the media asset. For example, control circuitry 704 determines a database that stores information about the user's subscription account for a content source providing media asset 3 (e.g., OTT source 1), located at any of storage 708, media content source 816 and media guidance data source 818. Process 1200 continues to 1210, where control circuitry 704 accesses the database corresponding to the user subscription to the content source providing the media asset to retrieve access right granted in the user subscription. For example, control circuitry 704 retrieves from the database associated with user's subscription account for OTT source 1, that the user has a basic subscription to OTT source 1.

Process 1200 continues to 1212, where control circuitry 704 determines whether the access right for the media asset corresponds to the access right granted in the user subscription. If, at 1212, control circuitry 704 determines that the access right for the media asset corresponds to the access right granted in the user subscription, process 1200 continues to 1214 where control circuitry 704 generates for display a notification that the action has occurred simultaneously with a portion of the media asset corresponding to the action. For example, control circuitry 704 may determine that the access right for media asset 3 (access granted to anyone with a basic subscription to OTT 1) corresponds to the access right granted in the user subscription (basic subscription) and generate for display display 100.

If, at 1212, control circuitry 704 determines that the access right for the media asset does not correspond to the access right granted in the user subscription, process 1200 continues to 1216. At 1216, control circuitry 704 generates for display a notification that the action has occurred simultaneously with an option to request access to the media asset. For example, control circuitry 704 may generate for display notification “dunk shot 10 minutes into the game, Apr. 19, 2016 Cleveland Cavaliers-Los Angeles Lakers 10:30 PM EST game” 202 and notification “You don't have access to this game highlight” 204 and selectable options “Request access” 210, “Request access” 216 and “Request access” 222.

It is contemplated that the steps or descriptions of FIG. 12 may be used with any other embodiment of this disclosure. In addition, the steps and descriptions described in relation to FIG. 12 may be done in alternative orders or in parallel to further the purposes of this disclosure. For example, each of these steps may be performed in any order or in parallel or substantially simultaneously to reduce lag or increase the speed of the system or method.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for providing users access to media content corresponding to actions that affect fantasy sports scores, the method comprising:
receiving a data structure that includes a first field corresponding to an action in a real-life sporting event that affects a fantasy sports score of a user and a second field corresponding to an identification of the real-life sporting event corresponding to the action;
retrieving metadata corresponding to media assets provided by a plurality of content sources;
parsing the metadata to determine real-life sporting events in each of the media assets;
comparing the real-life sporting events to the real-life sporting event to determine a media asset of the media assets corresponding to the real-life sporting event;
in response to determining the media asset corresponding to the real-life sporting event, determining an access right for the media asset;
comparing the access right for the media asset to an access right granted in a user subscription;
in response to the determining that the access right for the media asset corresponds to the access right granted in the user subscription, generating for display a notification that the action has occurred simultaneously with a portion of the media asset corresponding to the action.

2. The method of claim 1, further comprising:
receiving, in the data structure, a third field corresponding to a participant in the real-life sporting event corresponding to the action;
parsing the metadata to determine participants in each of the media assets; and
comparing participants to the participant to determine the media asset of the media assets corresponding to the real-life sporting event.

3. The method of claim 1, further comprising:
receiving, in the data structure, a fourth field corresponding to a game portion in the real-life sporting event corresponding to the action;
parsing the metadata to determine game portions in each of the media assets; and
comparing game portions to the game portion to determine the media asset of the media assets corresponding to the real-life sporting event.

4. The method of claim 1, further comprising:
determining that content source providing the media asset requires authentication credential;
accessing a profile data structure of the user corresponding to the content source to retrieve value of the authentication credential; and
providing the content source the authentication credential such that the user does not have to manually enter the authentication credential.

5. The method of claim 1, further comprising in response to the determining that the access right for the media asset does not correspond to the access right granted in the user subscription, generating for display the notification that the action has occurred without the portion of the media asset corresponding to the action.

6. The method of claim 5, further comprising including in the notification an option to request access to the media asset.

7. The method of claim 1 wherein the notification and the portion of the media asset corresponding to the action are displayed simultaneously with a program currently being displayed.

8. The method of claim 7, further comprising:
receiving a user selection of programs during which the notification and the portion of the media asset corresponding to the action are not to be displayed;
parsing metadata corresponding to the program currently being displayed to determine an identifier of the program currently being displayed;
determining that the program currently being displayed is included in the selection of programs during which the notification and the portion of the media asset corresponding to the action are not to be displayed by comparing the identifier of the program currently being displayed with identifiers of programs during which the notification is not to be displayed; and
in response to the determining that the program currently being displayed is included in the selection of programs, not generating for display the notification and the portion of the media asset corresponding to the action.

9. The method of claim 1, further comprising:
including in the notification an option to view the fantasy sports score of the user;
in response to receiving a selection of the option view the fantasy sports score of the user, retrieving a value corresponding to the fantasy sports score from a data structure corresponding to a fantasy sports team of the user; and
generating for display the fantasy sports score of the user.

10. The method of claim 1, further comprising:
receiving a user selection of actions in real-life sporting events that affect the fantasy sports score of the user for which the notification and the portion of the media asset corresponding to the action are not to be displayed;
determining that the action is included in the user selection of actions for which the notification and the portion of the media asset corresponding to the action are not to be displayed by comparing the first field corresponding to the action to fields corresponding to the user selection of actions; and
in response to the determining that the action is included in the user selection of actions, not generating for display the notification and the portion of the media asset corresponding to the action.

11. A system for providing users access to media content corresponding to actions that affect fantasy sports scores, the system comprising:
control circuitry configured to:
receive a data structure that includes a first field corresponding to an action in a real-life sporting event that affects a fantasy sports score of a user and a second field corresponding to an identification of the real-life sporting event corresponding to the action;
retrieve metadata corresponding to media assets provided by a plurality of content sources;
parse the metadata to determine real-life sporting events in each of the media assets;
compare the real-life sporting events to the real-life sporting event to determine a media asset of the media assets corresponding to the real-life sporting event;
in response to determining the media asset corresponding to the real-life sporting event, determine an access right for the media asset;
compare the access right for the media asset to an access right granted in a user subscription;
in response to the determining that the access right for the media asset corresponds to the access right granted in the user subscription, generate for display a notification that the action has occurred simultaneously with a portion of the media asset corresponding to the action.

12. The system of claim 11, wherein the control circuitry is further configured to:
receive, in the data structure, a third field corresponding to a participant in the real-life sporting event corresponding to the action;
parse the metadata to determine participants in each of the media assets; and
compare participants to the participant to determine the media asset of the media assets corresponding to the real-life sporting event.

13. The system of claim 11, wherein the control circuitry is further configured to:
receive, in the data structure, a fourth field corresponding to a game portion in the real-life sporting event corresponding to the action;
parse the metadata to determine game portions in each of the media assets; and
compare game portions to the game portion to determine the media asset of the media assets corresponding to the real-life sporting event.

14. The system of claim 11, wherein the control circuitry is further configured to:
determine that content source providing the media asset requires authentication credential;
access a profile data structure of the user corresponding to the content source to retrieve value of the authentication credential; and
provide the content source the authentication credential such that the user does not have to manually enter the authentication credential.

15. The system of claim 11, wherein the control circuitry is further configured to, in response to the determining that the access right for the media asset does not correspond to the access right granted in the user subscription, generate for display the notification that the action has occurred without the portion of the media asset corresponding to the action.

16. The system of claim 15, wherein the control circuitry is further configured to include in the notification an option to request access to the media asset.

17. The system of claim 11 wherein the control circuitry is further configured to display the notification and the portion of the media asset corresponding to the action simultaneously with a program currently being displayed.

18. The system of claim 17, wherein the control circuitry is further configured to:
receive a user selection of programs during which the notification and the portion of the media asset corresponding to the action are not to be displayed;
parse metadata corresponding to the program currently being displayed to determine an identifier of the program currently being displayed;
determine that the program currently being displayed is included in the selection of programs during which the notification and the portion of the media asset corresponding to the action are not to be displayed by comparing the identifier of the program currently being displayed with identifiers of programs during which the notification is not to be displayed; and
in response to the determining that the program currently being displayed is included in the selection of programs, not generate for display the notification and the portion of the media asset corresponding to the action.

19. The system of claim 11, wherein the control circuitry is further configured to:
include in the notification an option to view the fantasy sports score of the user;
in response to receiving a selection of the option view the fantasy sports score of the user, retrieve a value corresponding to the fantasy sports score from a data structure corresponding to a fantasy sports team of the user; and
generate for display the fantasy sports score of the user.

20. The system of claim 11, wherein the control circuitry is further configured to:
receive a user selection of actions in real-life sporting events that affect the fantasy sports score of the user for which the notification and the portion of the media asset corresponding to the action are not to be displayed;
determine that the action is included in the user selection of actions for which the notification and the portion of the media asset corresponding to the action are not to be displayed by comparing the first field corresponding to the action to fields corresponding to the user selection of actions; and
in response to the determining that the action is included in the user selection of actions, not generate for display the notification and the portion of the media asset corresponding to the action.

21-50. (canceled)
